(19) United States
(12) Patent Application Publication
(10) Pub. No.: US 2015/0030832 A1
(43) Pub. Date: Jan. 29, 2015

(54) TRANSPARENT LAYERED STRUCTURE AND METHOD FOR PRODUCING THE SAME

(71) Applicant: MAZDA MOTOR CORPORATION, Hiroshima (JP)

(72) Inventors: Daiji Katsura, Etajima-shi (JP); Takakazu Yamane, Hiroshima-shi (JP)

(73) Assignee: MAZDA MOTOR CORPORATION, Hiroshima (JP)

(21) Appl. No.: 14/385,966

(22) PCT Filed: Aug. 5, 2013
(86) PCT No.: PCT/JP2013/004731

§ 371 Date: Sep. 17, 2014

(30) Foreign Application Priority Data
Aug. 3, 2012 (JP) 2012-173009

(51) Int. Cl. B60J 1/20

(52) U.S. Cl. CPC B60J 1/2094
USPC 428/215; 428/325; 428/328; 427/515

(57) ABSTRACT

A transparent layered structure having a high abrasion resistance and a high scratch resistance and a method for producing such a transparent layered structure are provided. A transparent layered structure (1) includes: a plate-like transparent resin base (2); and a transparent protective film (3) located on one surface of the base (2). The heat resistance, for example, of the base (2) is set in a predetermined range so that a light-weight transparent layered structure (1) having a predetermined load resistance is achieved. The protective film (3) includes a silicone resin composition including 9 wt % or more of cage silsesquioxane and fine particles (4) constituted by glass fine particles or metal oxide fine particles subjected to a surface treatment with a silane compound under predetermined conditions. Thus, the transparent layered structure (1) obtains a high abrasion resistance and a high scratch resistance.

### TECHNICAL FIELD

The present invention relates to transparent layered structures for use as substitutes for window panes and other materials. Specifically, the present invention relates to a transparent layered structure having a desired strength and transparency and a method for producing such a transparent layered structure.

### BACKGROUND ART

Weight reduction has been required for vehicles in order to improve fuel efficiency. To achieve the weight reduction, a vehicle window material using a resin having a specific gravity lower than that of glass as its base has been developed.

It is important for the vehicle window material to maintain transparency in actual use environments. However, resins generally have poor abrasion resistance and poor scratch resistance to scratches, or scores, caused by car-washing brushes or other materials. Thus, resin window materials disadvantageously have insufficient transparency.

As a technique for solving such insufficient transparency, Patent Document 1, for example, describes a transparent structure in which a layered film is bonded to a glass surface with an adhesive layer interposed therebetween and in which the layered film is composed of a layer containing photo-curable cage silsesquioxane and its overlying transparent plastic film layer.

As another technique, Patent Document 2 shows transparent organic glass including a transparent resin base and a transparent protective film including cage silsesquioxane and a method for the transparent organic glass.

These techniques are expected to maintain transparency of a resin window material by using cage silsesquioxane for a protective film for protecting a transparent resin base.

In addition, Patent Document 3, for example, describes a transparent resin body in which silica fine particles are mixed in cage silsesquioxane. This technique is intended to increase dimensional stability to temperature changes.

### CITATION LIST

### Patent Document

PATENT DOCUMENT 1: Japanese Unexamined Patent Publication No. 2010-125719
PATENT DOCUMENT 2: Japanese Unexamined Patent Publication No. 2009-29881
PATENT DOCUMENT 3: International Publication WO2006-035646

### SUMMARY OF THE INVENTION

### Technical Problem

A vehicle window material also needs to have properties such as load resistance to a possible impact or load under actual use environments and high heat resistance in order to prevent cracks as well as the transparency. To substitute a conventional window pane with a resin window material while satisfying the above-described requirements, the elastic modulus and the heat resistance of a transparent resin base constituting a window material need to be appropriately selected. In addition, to achieve further weight reduction of the window material, the thickness of the transparent resin base also needs to be appropriately selected.

To obtain scratch resistance, it is preferable to increase the thickness of the transparent protective film sufficiently. However, in consideration of heat shrinkage, the thickness and the elastic modulus of the transparent resin base need to be set at predetermined values or less in order to prevent cracks in the protective film.

In Patent Documents 1 and 2, however, the elastic modulus and the thickness of the base are not determined in consideration of the load resistance and the heat resistance of the vehicle window material. The thickness range of the transparent protective film is not determined in consideration of the composition of the protective film, either, and measurements for preventing cracks in the protective film are not fully considered.

On the other hand, in a case where cage silsesquioxane containing silica fine particles described in Patent Document 3 is used for the transparent organic glass described in Patent Document 2, the silica fine particles cause shearing stress to be dispersed, resulting in the possibility of further increased abrasion resistance 1.

In this case, however, the presence of the silica fine particles, which are a type of glass fine particles having high hardness, causes cracks in the transparent protective film upon, for example, brushing depending on, for example, the content of the silica fine particles, and thereby, microfracture easily occurs in the protective film. Consequently, the scratch resistance deteriorates disadvantageously.

The foregoing problems are not limited to vehicle window materials. Similar problems might occur in typical resin window materials as substitutes for glass. Such typical resin window materials include window materials for mobile equipment and need performance substantially equivalent to that of vehicle window materials.

In view of this, according to the present invention, as a transparent layered structure for use as, for example, a resin window material for substituting glass, a transparent layered structure having high abrasion resistance and high scratch resistance is provided, and a method for producing such a transparent layered structure is also provided.

### Solution to the Problem

To achieve the object, in a first aspect of the invention, a transparent layered structure includes: a plate-like transparent resin base; and a transparent protective film located on at least one surface of the transparent resin base, wherein the transparent resin base has a heat resistance to temperatures greater than or equal to 70° C., the transparent protective film has a thickness greater than or equal to 10 μm and less than or equal to 80 μm, and includes a silicone resin composition including 9 wt % or more of cage silsesquioxane and fine particles constituted by glass fine particles or metal oxide fine particles subjected to a surface treatment with a silane compound and having a particle size greater than or equal to 10 nm and less than or equal to 100 nm, the fine particles have a weight proportion greater than or equal to 5 parts by weight and less than or equal to 400 parts by weight with respect to 100 parts by weight of the silicone resin composition, and the silane compound has a weight proportion greater than or equal to 15 wt % and less than or equal to 80 wt % with respect to the fine particles.

In a second aspect of the invention, the transparent resin base in the first aspect includes polycarbonate resin or acrylic resin, and has a substantially uniform thickness greater than or equal to 1 mm, an elastic modulus greater than or equal to 1 GPa at room temperature, and a Vickers hardness greater than or equal to 10 kgf/mm² at room temperature.

In a third aspect of the invention, a transparent layered structure includes: a plate-like transparent resin base; a transparent primer layer located on at least one surface of the transparent resin base; and a transparent protective film located on the transparent primer layer, wherein the transparent resin base has a heat resistance to temperatures greater than or equal to 70° C., the transparent protective film has a thickness greater than or equal to 5 μm and less than or equal to 80 μm, and includes a silicone resin composition including 9 wt % or more of cage silsesquioxane and fine particles subjected to a surface treatment with a silane compound and constituted by glass fine particles or metal oxide fine particles having a particle size greater than or equal to 10 nm and less than or equal to 100 nm, the fine particles have a weight proportion greater than or equal to 5 parts by weight and less than or equal to 400 parts by weight with respect to 100 parts by weight of the silicone resin composition, the silane compound has a weight proportion greater than or equal to 15 wt % and less than or equal to 80 wt % with respect to the fine particles, and the primer layer includes acrylic resin and has a thickness greater than or equal to 5 μm.

In a fourth aspect of the invention, the transparent resin base in the third aspect includes polycarbonate resin or acrylic resin, and has a substantially uniform thickness greater than or equal to 1 mm, an elastic modulus greater than or equal to 1 GPa at room temperature, and a Vickers hardness greater than or equal to 10 kgf/mm² at room temperature.

In a fifth aspect of the invention, the transparent layered structure of any one of the first through fourth aspects is a window material for an mobile object.

In a sixth aspect of the invention, a method for producing the transparent layered structure of the first or second aspect includes: a preparation step of preparing a plate-like transparent resin base having a heat resistance to temperatures greater than or equal to 70° C., a substantially uniform thickness greater than or equal to 1 mm at room temperature, and an elastic modulus greater than or equal to 1 GPa at room temperature; an application step of applying a coating composition including a silicone resin composition onto at least one surface of the transparent resin base; and a photocuring step of photocuring the coating composition with application of light at an ambient temperature lower than a heatproof temperature of the transparent resin base, thereby providing a transparent protective film on the transparent resin base, wherein the silicone resin composition to be used in the application step includes fine particles subjected to a surface treatment with a silane compound, and is constituted by glass fine particles or metal oxide fine particles having a particle size greater than or equal to 10 nm and less than or equal to 100 nm.

In a seventh aspect of the invention, a method for producing the transparent layered structure of the third or fourth aspect includes: a preparation step of preparing a plate-like transparent resin base having a heat resistance to temperatures greater than or equal to 70° C., a substantially uniform thickness greater than or equal to 1 mm, and an elastic modulus greater than or equal to 1 GPa at room temperature; a first application step of applying a coating composition including acrylic resin onto at least one surface of the transparent resin base; a second application step of applying a coating composition including a silicone resin composition including fine particles constituted by glass fine particles or metal oxide fine particles subjected to a surface treatment with a silane compound and having a particle size greater than or equal to 10 nm and less than or equal to 100 nm; and a photocuring step of photocuring the coating composition with application of light at an ambient temperature lower than a heatproof temperature of the transparent resin base, thereby providing a transparent primer layer and a transparent protective film on the transparent resin base.

### Advantages of the Invention

The foregoing configurations provide the following advantages.

In the first aspect, the heat resistance is set within a predetermined range. Thus, a transparent layered structure including a transparent protective film not susceptible to cracking is obtained. In addition, since the transparent protective film whose thickness is within a predetermined range in consideration of a cage silsesquioxane percentage (9 wt % or more) in the silicone resin composition as a main component is located on the transparent resin base, a transparent layered structure including a transparent protective film not susceptible to cracking with a high scratch resistance can be obtained.

In particular, since the transparent protective film includes fine particles constituted by glass fine particles or metal oxide fine particles subjected to a surface treatment with a silane compound, shearing stress on the transparent protective film can be dispersed by the fine particles having a high hardness. As a result, the abrasion resistance of the transparent layered structure can be enhanced. In addition, since the weight proportion of the silane compound to the fine particles, for example, is set within a predetermined range, microfracture, i.e., scratches, of the transparent protective film caused by cracking can be reduced. Thus, a transparent layered structure having both a high abrasion resistance and a high scratch resistance can be obtained.

The enhanced abrasion resistance and the enhanced scratch resistance of the transparent protective film lead to an increase in abrasion resistance and scratch resistance of the entire transparent layered structure.

In the second aspect, the thickness and the elastic modulus of the transparent resin base are set within predetermined ranges. Thus, the weight of the transparent layered structure can be reduced, and resistance to a possible impact or load under actual use environments can be obtained. In addition, the Vickers hardness of the transparent resin base is set within a predetermined range, and the thickness of the transparent protective film is set in a preferable range. Then, the scratch resistance can be further enhanced.

In the third aspect, the transparent primer layer including acrylic resin is interposed between the transparent resin base and the transparent protective film. Thus, part of the ultraviolet (UV) absorbing function and hot-wave absorbing function of the transparent protective film and part of the anti-crack function can be distributed to the transparent primer layer. Accordingly, yellowing can be reduced even in a case where a window material is used in severe environments, for example. As a result, the weather resistance of the transparent layered structure can be enhanced. Setting the thickness of the transparent protective film in a preferable range can further increase the scratch resistance.

If large amounts of a UV absorber a heat-wave absorber were included only in a transparent protective film, softening and curing inhibition in photocuring of the transparent protective film would occur. On the other hand, in this aspect, since the transparent primer layer can include a UV absorber and a heat-wave absorber, such disadvantages can be reduced. As a result, the weather resistance of the transparent layered structure can be further enhanced.

In the fifth aspect, a window material having both a high abrasion resistance and a high scratch resistance can be obtained.

In the sixth aspect, a transparent layered structure having both a high abrasion resistance and a high scratch resistance can be obtained. In general, transparent protective films are formed by baking. On the other hand, in the method of the sixth aspect, a transparent protective film can be promptly provided in the photocuring step. Thus, the yield can be increased as compared to a method including a baking step.

In the seventh aspect, similar advantages as those of the fourth aspect can be obtained, and a transparent layered structure with a high weather resistance can be produced.

### BRIEF DESCRIPTION OF THE DRAWINGS

FIG. 1 schematically illustrates a transparent layered structure according to a first embodiment of the present invention.

FIG. 2 is an enlarged view of a transparent protective film illustrated in FIG. 1.

FIG. 3 is a graph showing experimental results on the range of heat resistance of the transparent resin base.

FIG. 4 is a graph showing a range of an elastic modulus of the transparent resin base.

FIG. 5 shows a range of a particle size of fine particles.

FIG. 6A is a first illustration of advantages of the first embodiment, and FIG. 6B is an enlarged view of a square portion illustrated in FIG. 6A.

FIG. 7A is a second illustration of advantages of the first embodiment, and FIG. 7B is an enlarged view of a square portion illustrated in FIG. 7A.

FIG. 8 schematically illustrates a transparent layered structure according to a second embodiment of the present invention.

FIG. 9 is an enlarged view of a transparent protective film illustrated in FIG. 8.

FIG. 10 illustrates a test device for a scratch resistance test.

FIG. 11 illustrates a measurement device for measuring a surface gloss value.

FIG. 12 illustrates a test device for a weather resistance test.

### DESCRIPTION OF EMBODIMENTS

### Transparent Layered Structure of First Embodiment

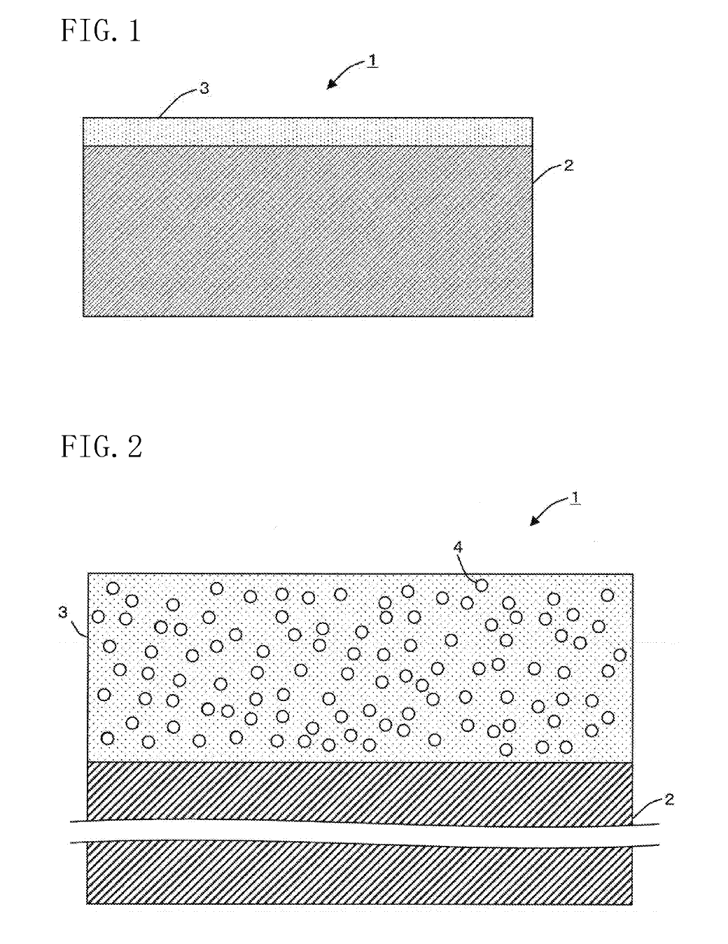

FIG. 1 schematically illustrates a transparent layered structure 1 according to a first embodiment of the present invention. FIG. 2 is an enlarged view of a transparent protective film 3 illustrated in FIG. 1. The transparent layered structure 1 of this embodiment includes a plate-like transparent resin base 2 and the transparent protective film 3 located on the transparent resin base 2. The transparent resin base 2 is composed of a visible light transmitting part that actually transmits light and a visible light non-transmitting part. In the transparent layered structure 1 illustrated in FIGS. 1 and 2, the transparent protective film 3 is provided only on one surface of the transparent resin base 2. Alternatively, the transparent protective film 3 may be provided on each surface of the transparent resin base 2.

The transparent resin base 2 includes polycarbonate resin or acrylic resin, e.g., methacrylate. In experiments that will be described in this embodiment, polycarbonate (L-1250: produced by Teijin Chemicals Ltd.) was used as the transparent resin base 2.

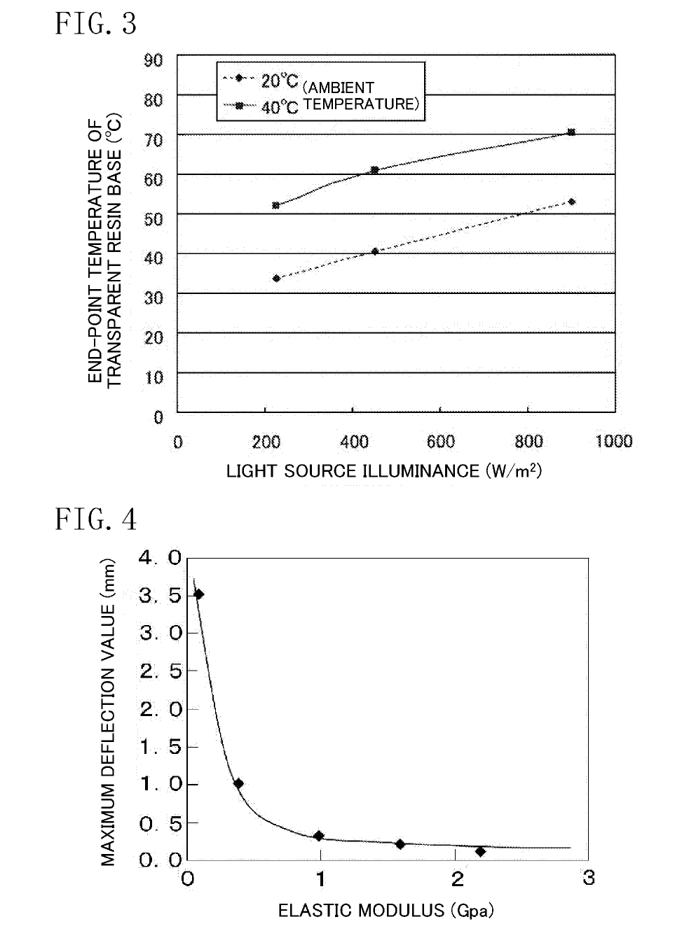

FIG. 3 shows experimental results on heat resistance of the transparent resin base 2. The transparent resin base 2 surrounded with a black box was irradiated with light with illuminances of 200 W/m², 400 W/m², and 900 W/m², which are expected in actual use environments, until the end-point temperature was saturated. The solid line in FIG. 3 indicates experimental results under a possible maximum ambient temperature of 40° C. in actual use environments. Experimental results at an ambient temperature of 20° C. are indicated by the dotted line for reference.

As shown in FIG. 3, the maximum end-point temperature at an ambient temperature of 40° C. was 70° C. Thus, the transparent resin base 2 preferably has heat resistance to temperatures greater than or equal to 70° C.

FIG. 4 shows an elastic modulus of the transparent resin base 2. In general, resin has a specific gravity about half of that of glass. A typical glass window pane for a vehicle has a thickness of about 3 mm. Thus, the thickness of the resin window material needs to be 6 mm or less in order to reduce the weight as compared to typical vehicles. FIG. 4 shows a relationship between an elastic modulus and a maximum deflection value of the transparent resin base 2 at room temperature when a load of 0.6 N was applied to a square transparent resin base 2 having a substantially uniform thickness of 1 mm and having its four sides fixed at 150 mm in accordance with JIS K 7191B.

In general, a vehicle window material needs to have a maximum deflection value of 0.34 mm or less under the above-described conditions. As shown in FIG. 4, when the maximum deflection value is 0.34 mm, the elastic modulus is 1 GPa. Thus, the transparent resin base 2 preferably has an elastic modulus of 1 GPa or more at room temperature.

When the transparent resin base 2 has a sufficiently high surface hardness, the transparent protective film 3 is easily deformed upon application of a load, and the deformation might increase damage on the transparent protective film 3. Thus, to provide the transparent layered structure 1 with a scratch resistance necessary for a window material of a vehicle, the transparent resin base 2 preferably has a Vickers hardness of 10 kgf/mm² or more at room temperature.

On the other hand, the transparent protective film 3 contains a silicone resin composition as a main component. The silicone resin composition contains cage silsesquioxane expressed by general formula (1):

[RSiO_{3/2}]ₙ (1)

(where R is a (meth)acryloyl group, a glycidyl group, a vinyl group, a guanyl group, an alkyl group, an epoxy group, or an organic functional group containing one of general formulas (2)-(4) below, and n is 8, 10, 12, or 14).

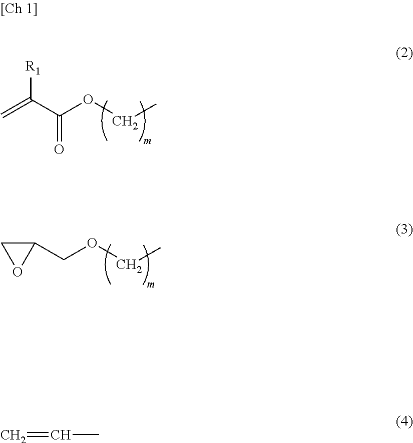

Examples of the silicone resin composition may include at least one of ladder silsesquioxane, random silsesquioxane, and incomplete cage silsesquioxane with lacking parts of cage.

The silicone resin composition may include an unsaturated compound in addition to silsesquioxane. Cage silsesquioxane is not limited to the foregoing structures, and may have other structures. The above-described structures may be used alone or in combination.

Specifically, examples of the unsaturated compound include vinyltrimethoxysilane, vinyltriethoxysilane, vinyltriacetoxysilane, γ-methacryloyloxypropyltrimethoxysilane, tricyclo[5.2.1.2,6]decane diacrylate (or dicyclopentenyl diacrylate), tricyclo[5.2.1.2,6]decane diacrylate, tricyclo[5.2.1.2,6]decanedimethacrylate, tricyclo[5.2.1.2,6]decanedimethacrylate, tricyclo[5.2.1.2,6]decane acrylate methacrylate, tricyclo[5.2.1.2,6]decane acrylate methacrylate, pentacyclo[6.5.1.13,6.2,7.9,13]pentadecane diacrylate, pentacyclo[6.5.1.13,6.2,7.9,13]pentadecane diacrylate, pentacyclo[6.5.1.13,6.2,7.9,13]pentadecanedimethacrylate, pentacyclo[6.5.1.13,6.2,7.9,13]pentadecanedimethacrylate, pentacyclo[6.5.1.13,6.2,7.9,13]pentadecane acrylate methacrylate, pentacyclo[6.5.1.13,6.2,7.9,13]pentadecane acrylate methacrylate, epoxy acrylate, epoxidized oil acrylate, urethane acrylate, unsaturated polyester, polyester acrylate, polyether acrylate, vinylacrylate, polyene/thiol, silicone acrylate, polybutadiene, polystyrylethyl methacrylate, styrene, vinyl acetate, N-vinylpyrrolidone, butyl acrylate, 2-ethylhexyl acrylate, n-hexyl acrylate, cyclohexyl acrylate, n-decyl acrylate, isobonyl acrylate, dicyclopentenyloxy ethyl acrylate, phenoxyethy lacrylate, trifluoroethyl methacrylate, tripropylene glycol diacrylate, 1,6-hexaenediol diacrylate, bisphenol A diglycidyl ether diacrylate, tetraethylene glycol diacrylate, hydroxypivallic acid neopentyl glycol diacrylate, trimethylolpropane triacrylate, pentaerythritol triacrylate, pentaerythritol tetraacrylate, dipentaerythritol hexaacrylate, and other reactive oligomers and monomers. The reactive oligomers and monomers may be used alone or two or more of the reactive oligomers and monomers may be used in combination.

In a case where the proportions of ladder silsesquioxane and random silsesquioxane are large and the proportion of cage silsesquioxane is small in the silicone resin composition, intermolecular cross-linking (curing) might not occur uniformly in the entire transparent protective film 3 in a photocuring step, which will be described later. In such a case, disadvantageously, a considerable degree of intermolecular cross-linking occurs, and cracks are likely to occur at a location where the volume of the transparent protective film 3 greatly shrinks. On the other hand, in a case where the proportion of cage silsesquioxane is large in the silicone resin composition, such a disadvantage does not arise. In view of this, the silicone resin composition of the transparent protective film 3 preferably includes 9 wt % or more of cage silsesquioxane.

As described above, depending on the proportion of cage silsesquioxane in the silicone resin composition, generation of intermolecular cross-linking in the photocuring step included in the method for producing the transparent layered structure 1 varies. Similarly, in actual use environments, scratch resistance of the transparent layered structure 1 and fragileness of the transparent protective film 3 depend on the change in proportion of cage silsesquioxane in the silicone resin composition. Thus, to obtain the transparent layered structure 1 with high scratch resistance and including the nonfragile transparent protective film 3, the thickness of the transparent protective film 3 preferably varies depending on the proportion of cage silsesquioxane in the silicone resin composition. In addition, the thickness of the transparent protective film 3 can be changed in consideration of the composition except cage silsesquioxane in the silicone resin composition.

In a case where the silicone resin composition includes 9 wt % or more of cage silsesquioxane, the transparent protective film 3 preferably has a thickness of 10 μm or more on the visible light transmitting part of the transparent resin base 2 in order to obtain high scratch resistance, and the transparent protective film 3 preferably has a thickness of 80 μm or less in order to prevent cracks in the transparent protective film 3 and obtain high scratch resistance. That is, with this proportion of cage silsesquioxane, the transparent protective film 3 preferably has a thickness of greater than or equal to 10 μm and less than or equal to 80 μm in order to obtain a high scratch resistance and prevent cracks.

The transparent protective film 3 includes fine particles 4 subjected to a surface treatment with a silane compound and constituted by glass fine particles or metal oxide fine particles. The glass fine particles are preferably silica glass fine particles (silica fine particles). The silane compound is preferably a compound expressed by, for example, general formula (5):

YₘSiAₙB₄₋ₘ₋ₙ (5).

where Y is a (meth)acryloyl group, a glycidyl group, a vinyl group, a guanyl group, an epoxy group, or an organic functional group including one of compounds expressed by general formulas (2)-(4), A is an alkyl group or another organic functional group, B is a hydroxyl group, an alkoxyl group or halogen atoms, m is an integer of 0-1, n is an integer of 0-3, and m+n is greater than or equal to 1 and less than or equal to 3.

Specifically, examples of the silane compound include 3-acryloxypropyldimethylmethoxysilane, 3-acryloxypropylmethyldimethoxysilane, 3-acryloxypropyldiethylmethoxysilane, 3-acryloxypropylethyldimethoxysilane, 3-acryloxypropyltrimethoxysilane, 3-acryloxypropyldimethylethoxysilane, 3-acryloxypropylmethyldiethoxysilane, 3-acryloxypropyldiethylethoxysilane, 3-acryloxypropylethyldiethoxysilane, 3-acryloxypropyltriethoxysilane, 3-methacryloxypropyldimethylmethoxysilane, 3-methacryloxypropylmethyldimethoxysilane, 3-methacryloxypropyldiethylmethoxysilane, 3-methacryloxypropylethyldimethoxysilane, 3-methacryloxypropyltrimethoxysilane, 3-methacryloxypropyldimethylethoxysilane, 3-methacryloxypropylmethyldiethoxysilane, 3-methacryloxypropyldiethylethoxysilane, 3-methacryloxypropylethyldiethoxysilane, 3-methacryloxypropyltriethoxysilane, methyl trimethoxysilane, dimethyl dimethoxysilane, trimethoxysilane, ethyltrimethoxysilane, diethyldimethoxysilane, triethylmethoxysilane, propyltrimethoxysilane, dipropyltrimethoxysilane, tripropylmethoxysilane, isopropyltrimethoxysilane, diisopropyldimethoxysilane, triisopropylmethoxysilane, methyltriethoxysilane, dimethyldiethoxysilane, triethoxysilane, ethyltriethoxysilane, diethyldiethoxysilane, triethylethoxysilane, propyltriethoxysilane, dipropyltriethoxysilane, tripropylethoxysilane, isopropyltriethoxysilane, diisopropyldiethoxysilane, and triisopropylethoxysilane. These compounds may be used alone or two or more of these compounds may be used in combination.

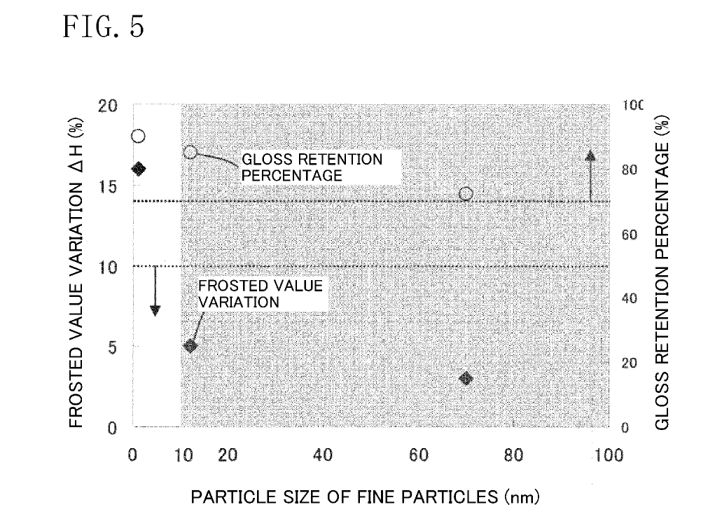

FIG. 5 shows results of an abrasion resistance test and a scratch resistance test, which will be described later, in which the particle size of the fine particles 4 in the transparent layered structure 1 was varied. FIG. 5 shows test results on the transparent layered structure 1 in which the thickness of the transparent protective film 3 was 30 μm. The weight proportion of the silane compound in the fine particles 4, which will be described later, was 23%. When a frosted value variation ΔH is 10% or more, a decrease in visibility of a transmission image is readily recognized. Thus, it can be determined that a high abrasion resistance is obtained when the frosted value variation AH is less than 10%. Similarly, when a gloss retention percentage is less than 70%, a decrease in visibility of a transmission image is readily recognized. Thus, it can be determined that a high scratch resistance is obtained when the gloss retention percentage exceeds 70%.

As described below, when the particle size of the fine particles 4 is in the range from 10 nm to 100 nm, both inclusive, the frosted value variation AH is less than 10% and the gloss retention percentage exceeds 70%. Thus, to obtain both a high abrasion resistance and a high scratch resistance, the fine particles 4 preferably have a particle size greater than or equal to 10 nm and less than or equal to 100 nm.

To obtain both a high abrasion resistance and a high scratch resistance, the silane compound preferably has a weight proportion greater than or equal to 15 wt % and less than or equal to 80 wt % with respect to the fine particles 4. Similarly, the fine particles 4 preferably have a weight proportion greater than or equal to 5 parts by weight and less than or equal to 400 parts by weight with respect to 100 parts by weight of the silicone resin composition.

The transparent protective film 3 may include an ultraviolet (UV) absorber and a light stabilizer, for example. Examples of the UV absorber include a hydroxyphenyltriazine-based organic UV absorber. Examples of the light stabilizer include a hindered amine-based light stabilizer.

Specifically, examples of the UV absorber include: benzophenones such as 2,4-dihydroxybenzophenone, 2-hydroxy-4-methoxybenzophenone, 2-hydroxy-4-octoxybenzophenone, and 2,2′-dihydroxy-4,4′-dimethoxybenzophenone; benzotriazoles such as 2-(5′-methyl-2′-hydroxy phenyl)benzotriazole, 2-(3′-t-butyl-5′-methyl-2′-hydroxy phenyl)benzotriazole, and 2-(3′,5′-di-t-butyl-2′-hydroxy phenyl)-5-chlorobenzotriazole; cyanoacrylates such as ethyl-2-cyano-3,3-diphenyl acrylate and 2-ethylhexyl-2-cyano-3,3-diphenyl acrylate; salicylates such as phenylsalicylate and p-octylphenyl salicylate; benzylidene malonates such as diethyl-p-methoxybenzylidene malonate and bis(2-ethylhexyl)benzylidene malonate; triazines such as 2-(4,6-diphenyl-1,3,5-triazine-2-yl)-5-[(methyl)oxy]-phenol, 2-(4,6-diphenyl-1,3,5-triazine-2-yl)-5-[(ethyl)oxy]-phenol, 2-(4,6-diphenyl-1,3,5-triazine-2-yl)-5-[(propyl)oxy]-phenol, 2-(4,6-diphenyl-1,3,5-triazine-2-yl)-5-[(butyl)oxyl-phenol, and 2-(4,6-diphenyl-1,3,5-triazine-2-yl)-5-[(hexyl)oxy]-phenol; copolymer of 2-(2′-hydroxy-5-methacryloxyethylphenyl)-2H-benzotriazole and vinyl monomer copolymerizable with this monomerl; copolymer of 2-(2′-hydroxy-5-acryloxyethylphenyl)-2H-benzotriazole and vinyl monomer copolymerizable with this monomer; and fine particles of metal oxides such as titanium oxide, cerium oxide, zinc oxide, tin oxide, tungsten oxide, zinc sulfide, and cadmium sulfide. These UV absorbers may be used alone, or two or more of these UV absorbers may be used in combination.

Examples of the light stabilizer include: hindered amines such as bis(2,2,6,6-tetramethyl-4-piperidyl)carbonate, bis(2,2,6,6-tetramethyl-4-piperidyl)succinate, bis(2,2,6,6-tetramethyl-4-piperidyl)sebacate, 4-benzoyloxy-2,2,6,6-tetramethylpiperidine, 4-octanoyloxy-2,2,6,6-tetramethylpiperidine, bis(2,2,6,6-tetramethyl-4-piperidyl)diphenylmethane-p,p′-dicarbamate, bis(2,2,6,6-tetramethyl-4-piperidyl)benzene-1,3-disulfonate, and bis(2,2,6,6-tetramethyl-4-piperidyl)phenyl phosphate; and nickel complexes such as nickel bis(octylphenyl)sulfide, nickel complex-3,5-di-t-butyl-4-hydroxybenzyl phosphoric acid monoethylate, and nickel dibutyl dithiocarbamate. These light stabilizers may be used alone or two or more of these light stabilizers may be used in combination.

As described above, in the transparent layered structure 1 of this embodiment, the thickness, the elastic modulus, and the Vickers hardness of the transparent resin base 2 are set within predetermined ranges. In this manner, the transparent layered structure 1 has a load resistance to a possible impact or load under actual use environments with reduced weight. In addition, since the heat resistance is set within the predetermined range, the transparent protective film 3 of the transparent layered structure 1 is not susceptible to cracking. Further, since the transparent protective film 3 whose thickness is within the predetermined range in consideration of the proportion of cage silsesquioxane in the silicone resin composition as a main component is provided on the transparent resin base 2, the transparent protective film 3 of the transparent layered structure 1 has a high abrasion resistance and a high scratch resistance and is not susceptible to cracking.

Moreover, since the transparent resin base 2 includes versatile polycarbonate resin or acrylic resin, the transparent layered structure 1 can be easily produced.

In a case where the transparent protective film 3 includes an UV absorber, the UV absorbency and heat-wave absorbency of the transparent protective film 3 can be enhanced. In addition, the presence of the light stabilizer in the transparent protective film 3 can reduce deterioration of the transparent layered structure 1 caused by, for example, UV. As a result, weather resistance of the transparent layered structure 1 can be enhanced.

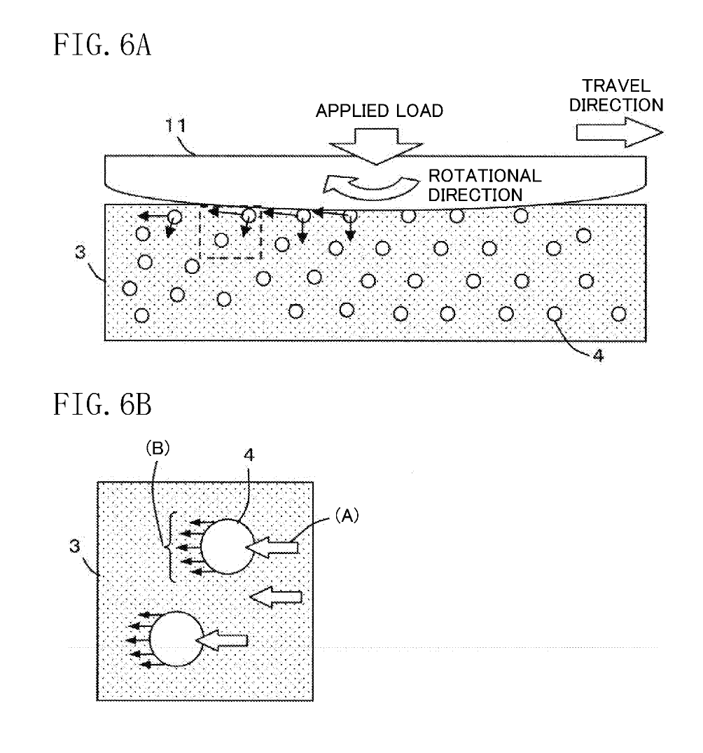

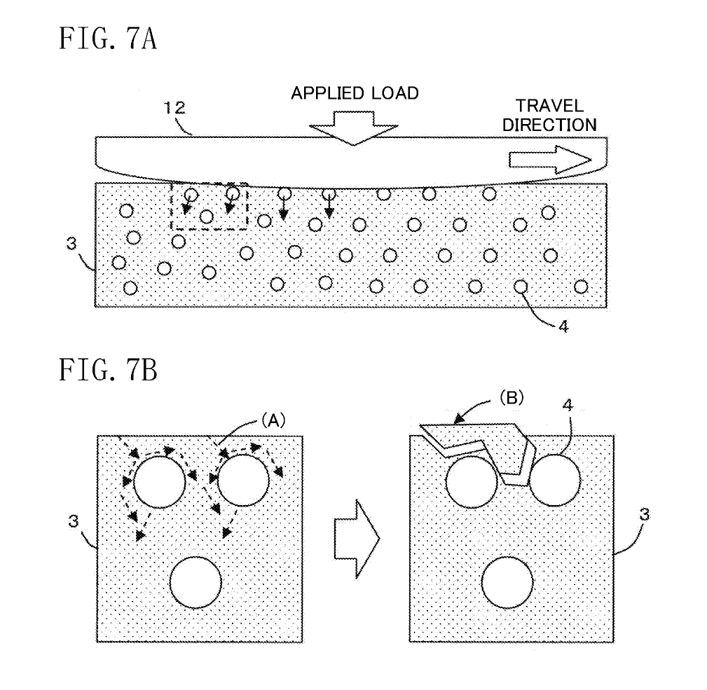

Referring now to FIGS. 6A, 6B, 7A, and 7B, advantages obtained by the presence of the fine particles 4 in the transparent layered structure 1 will be described.

FIG. 6A illustrates a state in which an abrasion disc 11 including a glass material is rotated and moves forward and backward relative to the transparent protective film 3 so that a load is applied to the transparent protective film 3. FIGS. 6A and 6B show a taper abrasion test in conformity with JIS R 3212, which will be described later. In this test, it is expected that although rotation of the abrasion disc 11 applies shearing stress in the direction indicated by arrow A in FIG. 6B, this shearing stress is dispersed by the fine particles 4 having a particle size sufficiently larger than that of a material constituting the transparent protective film 3. Thus, peeling of the transparent protective film 3 into flake shapes can be reduced, and thereby, a high abrasion resistance of the transparent layered structure 1 can be obtained.

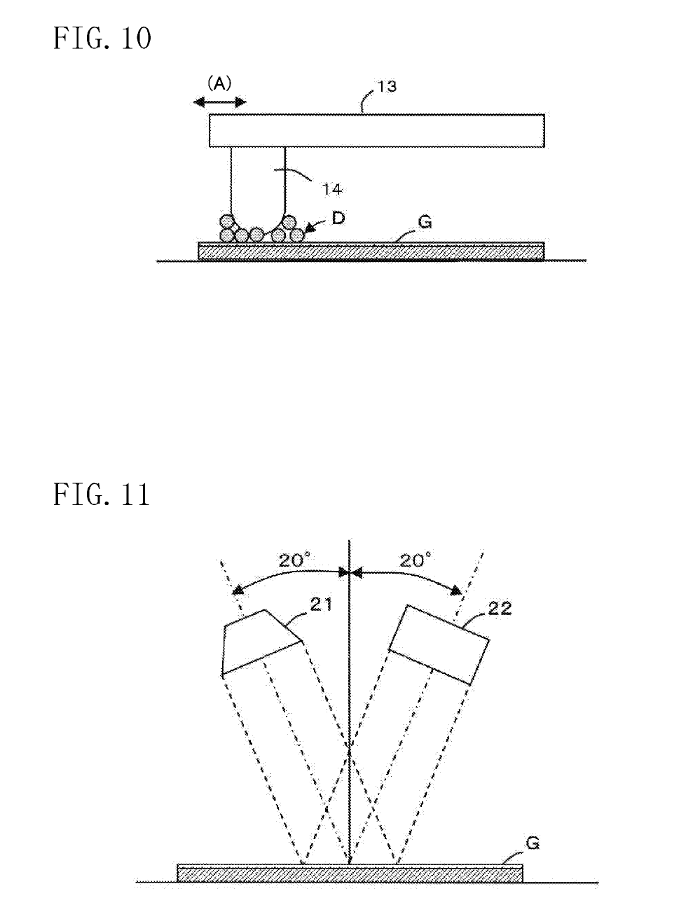

FIG. 7A illustrates a state in which a scratcher 12 including a glass material moves forward and backward relative to the transparent protective film 3 so that a load is applied to the transparent protective film 3. FIGS. 7A and 7B show a scratch resistance test (see FIG. 10), which will be described later. In this test, the presence of the fine particles 4 having a hardness higher than that of the material constituting the transparent protective film 3 accelerates crack formation in the transparent protective film 3 as indicated by arrow A in FIG. 7B. Accordingly, as indicated by arrow B in FIG. 7B, microfracture, i.e., scratches, might occur in the transparent protective film 3.

In this embodiment, in an abrasion resistance test, and the scratch resistance test, which will be described later, since the transparent protective film 3 includes the fine particles 4 constituted by glass fine particles or metal oxide fine particles under predetermined conditions, both a high abrasion resistance and a high scratch resistance can be obtained at the same time. The predetermined conditions are that the particle size of the fine particles 4 is greater than or equal to 10 nm and less than or equal to 100 nm, the weight proportion of the fine particles 4 is greater than or equal to 5 parts by weight and less than or equal to 400 parts by weight with respect to the silicone resin composition, and the weight proportion of the silane compound in the fine particles 4 is greater than or equal to 15 wt % and less than or equal to 80 wt %. In this manner, the transparent layered structure 1 fully satisfying requirements for taper abrasion employed in, for example, the JIS standard (JIS R 3212) can be obtained.

In addition, in this embodiment, the fine particles 4 of glass fine particles or metal oxide fine particles have a predetermined range of particle size and are subjected to a surface treatment with the silane compound having a predetermined range of weight proportion. Thus, the fine particles 4 can be appropriately dispersed in the transparent protective film 3, and a covalent bond between the fine particles 4 and the silicone resin composition in the transparent protective film 3 can be achieved. Thus, the abrasion resistance and the scratch resistance of the transparent layered structure 1 against the fine particles 4 can be enhanced. With some compositions of the silane compound, intermolecular force due to, for example, a hydrogen bond or a π (pi) bond, can be applied between the silane compound used in the surface treatment on the fine particles 4 and the silicone resin composition of the transparent protective film. In this case, the abrasion resistance and the scratch resistance of the transparent layered structure 1 against the fine particles 4 can be further enhanced.

(Method for Producing Transparent Layered Structure of First Embodiment)

A method for producing a transparent layered structure 1 according to the first embodiment includes: a preparation step of preparing a transparent resin base 2 described above; an application step of applying a coating composition constituting a transparent protective film 3 on at least one surface of the transparent resin base 2; and a photocuring step of photocuring the coating composition with application of light at an ambient temperature lower than a heatproof temperature of the transparent resin base 2 so that the transparent protective film 3 is formed on the transparent resin base 2.

In the application step, the coating composition includes a silicone resin composition, a nonpolar solvent, a basic catalyst, and a photopolymerization initiator, and a solution of the coating composition is casted. The silicone resin composition may be cage silsesquioxane or a mixture of cage silsesquioxane, ladder silsesquioxane, and random silsesquioxane. The silicone resin composition preferably includes fine particles of glass fine particles or metal oxide fine particles subjected to a surface treatment with a silane compound and having a particle size greater than or equal to 10 nm and less than or equal to 100 nm. The nonpolar solvent is preferably a poorly water-soluble solvent with a low boiling point. The basic catalyst may be an alkali metal hydroxide or ammonium salt hydroxide such as tetramethyl ammonium hydroxide, and is preferably a catalyst soluble in a nonpolar solvent. Examples of the photopolymerization initiator include acetophenone-based compounds, benzoin-based compounds, benzophenone-based compounds, thioxanthone-based compounds, and acyl phosphine oxide-based compounds. The photopolymerization initiator may also include a photoinitiator and a sensitizer, which are advantageous in combination with the photopolymerization initiator.

Specifically, examples of the nonpolar solvent include: ketones such as acetone, methyl ethyl ketone, methyl isobutyl ketone, and cyclohexanone; ethers such as tetrahydrofuran, 1,4-dioxane, and 1,2-dimethoxyethane; esters such as ethyl acetate and ethoxyethyl acetate; alcohols such as methanol, ethanol, 1-propanol, 2-propanol, 1-butanol, 2-butanol, 2-methyl-1-propanol, 2-methyl-2-propanol, 2-ethoxyethanol, 1-methoxy-2-propanol, and 2-botoxyethanol; hydrocarbons such as n-hexane, n-heptane, isooctane, benzene, toluene, xylene, gasoline, light oil, and kerosene; acetonitrile; nitromethane; and water. These nonpolar solvents may be used alone or two or more of the nonpolar solvents may be used in combination.

Examples of the photopolymerization initiator include trichloroacetophenone, diethoxyacetophenone, 1-phenyl-2-hydroxy-2-methylpropane-1-one, 1-hydroxycyclohexyl phenyl ketone, 2-methyl-1-(4-methylthiophenyl)-2-morpholinopropane-1-one, benzoin methyl ether, benzyl dimethyl ketal, benzophenone, thioxanthone, 2,4,6-trimethylbenzoyldiphenylphosphineoxide, methyl phenyl glyoxylate, camphor quinone, benzyl, anthraquinone, and Michler's ketone. These photopolymerization initiators may be used alone or two or more of the photopolymerization initiators may be used in combination.

In the application step, the use of the coating composition including a UV absorber and a light stabilizer enables formation of the transparent layered structure 1 in which the transparent protective film 3 contains the UV absorber.

In the application step, the coating composition may include, as an additive, at least one of an organic/inorganic filler, a plasticizer, a flame retardant, a heat stabilizer, an antioxidant, a lubricant, an antistatic agent, a releasing agent, a foaming agent, a nucleating agent, a coloring agent, a cross-linking agent, a dispersing agent, and a resin component, for example.

Before the application step, the method may include the step of bonding a spacer to the transparent resin base 2 such that the transparent protective film 3 has a predetermined thickness. After the application step, the method may include the step of heating the transparent resin base 2 at a temperature of, for example, 80° C., sufficiently lower than the heatproof temperature of the transparent resin base 2 and removing an unnecessary part of the coating composition by using a film or other materials provided on the coating composition.

In the photocuring step, light is applied with, for example, a mercury lamp under conditions that the illuminance in the wavelength range from 200 nm to 400 nm, both inclusive, is greater than or equal to 1×10⁻² m W/cm² and less than or equal to 1×10⁴ mW/cm² and a cumulative luminous energy in the wavelength range is greater than or equal to 5×10² mJ/cm² and less than or equal to 3×10⁴ mJ/cm².

The photocuring step may be performed under a pressure release, and is preferably performed in an atmosphere in which a nitrogen purge is carried out such that the oxygen partial pressure is reduced to an atmospheric pressure or less, preferably to 1% or less. The photocuring step may also be performed with a gas whose oxygen partial pressure is reduced below the atmospheric pressure, e.g., a gas as a mixture of the air and nitrogen, being blown onto the surface of the coating composition. In addition, the photocuring step may be performed with a transparent member, such as a transparent film, an organic composition that does not cause curing reaction with the coating composition, a lamination, or glass, being disposed on top of the surface. The method may include a heating step before the photocuring step.

As described above, with the method for producing the transparent layered structure 1 of this embodiment, the transparent layered structure 1 having a high abrasion resistance and a high scratch resistance can be produced. In addition, since the photocuring step allows the transparent protective film 3 to be formed more promptly, the yield can be increased as compared to a method including a baking step. Further, since the photocuring step is performed with the above-described illuminance and cumulative luminous energy, the photocuring step and the entire method can be simplified.

The photocuring reaction is a free radical reaction, and is inhibited by oxygen. As described above, when the photocuring step is performed with the oxygen partial pressure being reduced to the atmospheric pressure or less, preferably 1% or less, the oxygen inhibition can be reduced. In addition, since the heating step is performed before the photocuring step, smoothness of the transparent layered structure 1 can be enhanced. Further, since the photocuring step is performed with the transparent member being disposed on top of the surface, smoothness of the transparent layered structure 1 can be enhanced.

(Transparent Layered Structure of Second Embodiment)

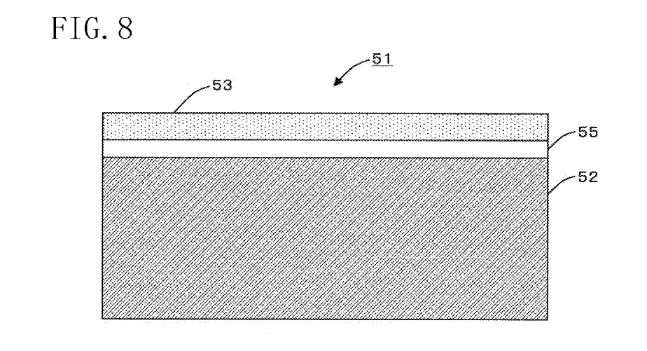

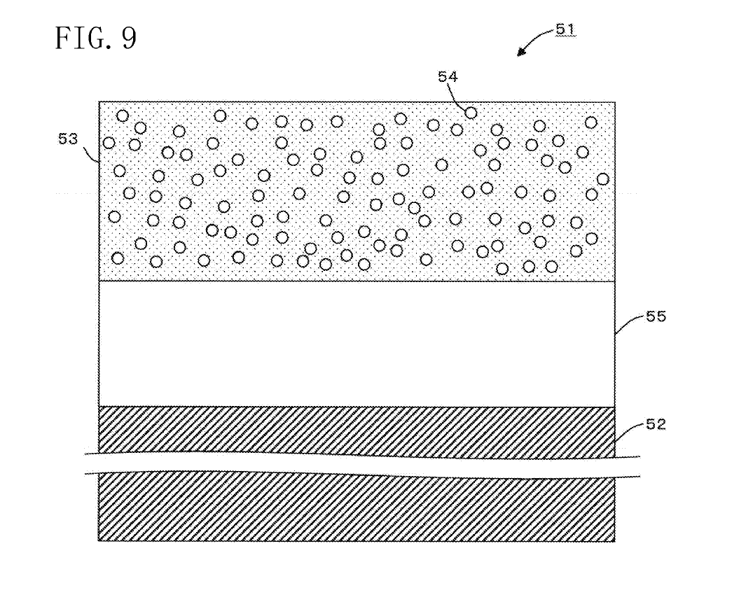

FIG. 8 schematically illustrates a transparent layered structure 51 according to a second embodiment of the present invention. FIG. 9 is an enlarged view including a transparent protective film 53 illustrated in FIG. 8. The transparent layered structure 51 of this embodiment includes a plate-like transparent resin base 52, a transparent protective film 53 located on the transparent resin base 52, and a transparent primer layer 55 interposed between the transparent resin base 52 and the transparent protective film 53. In the transparent layered structure 51 illustrated in FIG. 8, the transparent protective film 53 is provided only on one surface of the transparent resin base 52. Alternatively, the transparent protective film 53 may be provided on each surface of the transparent resin base 52.

The transparent layered structure 51 of this embodiment includes the transparent primer layer 55. In a case where a silicone resin composition includes 9 wt % or more of cage silsesquioxane, the transparent protective film 53 preferably has a thickness of 5 μm or more on a visible light transmitting part of the transparent resin base 2 in order to obtain a high scratch resistance. That is, with this proportion of cage silsesquioxane, the transparent protective film 53 preferably has a thickness greater than or equal to 5 μm and less than or equal to 80 μm in order to obtain a high scratch resistance and prevent cracks. In this point, the transparent layered structure 51 of the second embodiment is different from the transparent layered structure 1 of the first embodiment. The other part of the configuration of the second embodiment is similar to that of the first embodiment, and description thereof is not repeated.

To obtain a high weather resistance, the transparent primer layer 55 preferably has a thickness of 5 μm or more and contains an acrylic copolymer composition. The acrylic copolymer composition includes 10 wt % or more and 100 wt % or less of an alicyclic unsaturated compound. The alicyclic unsaturated compound is, for example, diacrylate expressed by general formula (6) below. The acrylic copolymer composition can perform radical polymerization with a silicone resin composition, which is a main component of the transparent protective film 53.

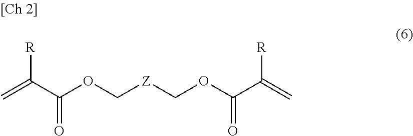

In general formula (6), R is hydrogen atoms or a methyl group, and Z is expressed by formula (7) or (8):

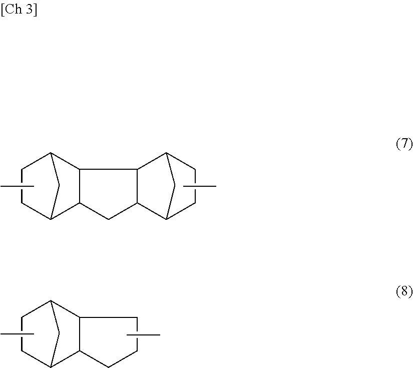

Specifically, the alicyclic unsaturated compound may be tricyclo[5.2.1.2,6]decane diacrylate (or dicyclopentenyl diacrylate), and may also be tricyclo[5.2.1.2,6]decane diacrylate, tricyclo[5.2.1.2,6]decane dimethacrylate, tricyclo[5.2.1.2,6]decane dimethacrylate, tricyclo[5.2.1.2,6]decane acrylate methacrylate, tricyclo[5.2.1.2,6]decane acrylate methacrylate, pentacyclo[6.5.1.13,6.02,7.09,13]pentadecane diacrylate, pentacyclo[6.5.1.13,6.02,7.09,13]pentadecane diacrylate, pentacyclo[6.5.1.13,6.02,7.09,13]pentadecane dimethacrylate, pentacyclo[6.5.1.13,6.02,7.09,13]pentadecane dimethacrylate, pentacyclo[6.5.1.13,6.02,7.09,13]pentadecane acrylate methacrylate, pentacyclo[6.5.1.13,6.02,7.09,13]pentadecane acrylate methacrylate, for example. These compounds may be used alone or two or more of the compounds may be used in combination.

The acrylic copolymer composition may include an acyclic unsaturated compound, in addition to the alicyclic unsaturated compound. Unsaturated compounds are generally classified into: a reactive oligomer as a polymer having the number of repetition of structural units of about 2 to 20; and a reactive monomer having a low molecular weight and a low viscosity. The unsaturated compounds are generally classified into: a monofunctional unsaturated compound having one unsaturated group; and a polyfunctional unsaturated compound having a plurality of unsaturated groups.

In this embodiment, examples of the reactive oligomer include epoxy acrylate, epoxidized oil acrylate, urethane acrylate, unsaturated polyester, polyester acrylate, polyether acrylate, vinylacrylate, polyene/thiol, silicone acrylate, polybutadiene, and polystyrylethyl methacrylate. Examples of the reactive monofunctional monomer include styrene, vinyl acetate, N-vinylpyrrolidone, butyl acrylate, 2-ethylhexyl acrylate, n-hexyl acrylate, cyclohexyl acrylate, n-decyl acrylate, isobonyl acrylate, dicyclopentenyloxy ethyl acrylate, phenoxyethyl acrylate, and trifluoroethyl methacrylate. Examples of the reactive polyfunctional monomer include unsaturated compounds except unsaturated compounds expressed by general formula (4) above, such as tripropylene glycol diacrylate, 1,6-hexaenediol diacrylate, bisphenol A diglycidyl ether diacrylate, tetraethylene glycol diacrylate, hydroxypivallic acid neopentyl glycol diacrylate, trimethylolpropane triacrylate, pentaerythritol triacrylate, pentaerythritol tetraacrylate, and dipentaerythritol hexaacrylate. The unsaturated compound used in this embodiment may be other reactive oligomers or reactive monomers. These reactive oligomers and reactive monomers may be used alone or two or more of the reactive oligomers and the reactive monomers may be used in combination.

The transparent primer layer 55 may include, as a photopolymerization initiator, a compound such as an acetophenone-based compound, a benzoin-based compound, a benzophenone-based compound, a tahioxanthone-based compound, or an acyl phosphine oxide-based compound. The photopolymerization initiator serves as a polymerization initiator in a photocuring step included in a method for producing the transparent layered structure 51, which will be described later. The transparent primer layer 55 may also include a photoinitiator and a sensitizer, which are advantageous in combination with the photopolymerization initiator.

Specifically, examples of the photopolymerization initiator include: trichloroacetophenone, diethoxyacetophenone, 1-phenyl-2-hydroxy-2-methyl propane-1-one, 1-hydroxy cyclohexyl phenylketone, 2-methyl-1-(4-methylthiophenyl)-2-morpholinopropane-1-one, benzoin methyl ether, benzyl dimethyl ketal, benzophenone, thioxanthone, 2,4,6-trimethylbenzoyldiphenylphosphineoxide, methyl phenyl glyoxylate, camphor quinone, benzyl, anthraquinone, and Michler's ketone.

At least one of the transparent protective film 53 or the transparent primer layer 55 may include a UV absorber and a light stabilizer, for example, described in the first embodiment.

As described above, the transparent layered structure 51 of this embodiment has the following advantages as well as those obtained by the transparent layered structure 1 of the first embodiment. Specifically, part of the UV absorption function and the heat-wave absorption function obtained by the transparent protective film 53 can be distributed to the transparent primer layer 55. Since the transparent primer layer 55 can include the UV absorber and the heat-wave absorber, it is possible to reduce softening of the transparent protective film 53 and curing inhibition during photocuring, which can occur when only the transparent protective film 53 includes large amounts of the UV absorber and the heat-wave absorber. Thus, a high abrasion resistance and a high scratch resistance of the transparent protective film 53 of the transparent layered structure 51 can be obtained, and the weather resistance can be enhanced. In this manner, the transparent layered structure 51 suitable for use in vehicle windows capable of withstanding a long-term use can be obtained.

As described above, the presence of the primer layer 55 can reduce deformation that accelerates cracking of the transparent protective film 53 upon application of a load to the transparent protective film 53. Thus, part of the anti-crack function of the transparent protective film 53 can be distributed to the transparent primer layer 55.

(Method for Producing Transparent Layered Structure of Second Embodiment)

A method for producing the transparent layered structure 51 according to the second embodiment includes: a preparation step of preparing the transparent resin base 52; a first application step of applying a coating composition constituting the transparent primer layer 55 on at least one surface of the transparent resin base 52; a second application step of applying a coating composition constituting the transparent protective film 53 on the coating composition constituting the transparent primer layer 55; and a photocuring step of photocuring the coating composition with application of light at an ambient temperature lower than a heatproof temperature of the transparent resin base 52 so that the transparent primer layer 55 and transparent protective film 53 are formed on the transparent resin base 52.

In the method for producing the transparent layered structure 51, so-called wet-on-wet coating in which the coating composition constituting the transparent protective film 53 is applied before the coating composition constituting the transparent primer layer 55 is dried may be performed. In the case of performing the wet-on-wet coating, heating or optical illumination may be performed only in a short period between the first application step and the second application step.

In the first and second application steps, a coating composition similar to that used in the application step of the first embodiment may be used. In the photocuring step, photocuring of the coating composition can be performed under conditions similar to those in the photocuring step of the first embodiment.

As described above, with the method for producing the transparent layered structure 51 of this embodiment, a transparent layered structure 51 having a high weather resistance as well as a high abrasion resistance and a high scratch resistance can be produced. In addition, since the photocuring step allows the transparent primer layer 55 and the transparent protective film 53 to be formed more promptly, the yield can be increased as compared to a method including a baking step. In the wet-on-wet coating, heating or optical illumination performed only in a short period between the first application step and the second application step can prevent the coating composition constituting the transparent primer layer 55 from being mixed with the coating composition constituting the transparent protective film 53 in the second application step. As a result, redundant coating composition generated at the second application step can be efficiently collected.

The foregoing description is directed to the embodiments of the present invention. However, the present invention is not limited to these embodiments, and of course, various modifications and design changes may be made without departing from the scope of the invention.

### EXAMPLES

A transparent layered structure and a method for producing a transparent layered structure according to the present invention will now be described with reference to examples and comparative examples. However, the present invention is not limited to the following examples. In examples, “part(s)” and “%” respectively refer to “part(s) by weight” and “wt %.” In the following examples, silica fine particles are used as glass fine particles.

### Synthesis Example of Silicone Resin Composition

### Synthesis Example 1

To a reaction vessel equipped with a stirrer, a dropping funnel, and a thermometer, 40 ml of 2-propanol (IPA) as a solvent and a 5% aqueous solution of tetramethyl ammonium hydroxide (an aqueous solution of TMAH) as a basic catalyst were fed. To the dropping funnel, 15 ml of IPA and 12.69 g of 3-methacryloxypropyltrimethoxysilane (SZ-6030: produced by Dow Corning Toray Co., Ltd.) was fed. Then, an IPA solution of 3-methacryloxypropyltrimethoxysilane was dropped over 30 minutes at room temperature while the mixture in the reaction vessel was stirred. After the dropping, the mixture was stirred for two hours without being heated. Subsequently, the solvent was removed under reduced pressure, and the remainder was dissolved into 50 ml of toluene. After the reaction liquid had been washed with a saturated salt solution so as to be neutral, the resultant was dehydrated with anhydrous magnesium sulfate. Then, anhydrous magnesium sulfate was filtered out and the remainder was concentrated. As a result, 8.6 g of hydrolysate (silsesquioxane) was obtained. The silsesquioxane was a colorless viscous liquid soluble in various organic solvents. Thereafter, to a reaction vessel equipped with a stirrer, a dienstag, and a cooling pipe, 20.65 g of the silsesquioxane thus obtained, 82 ml of toluene, and 3.0 g of a 10% aqueous solution of TMAH were fed, and the whole was gradually heated to distill water off. The remainder was additionally heated to 130° C., and a recondensation reaction of toluene was performed at a reflux temperature. The temperature of a reaction liquid at this time was 108° C. After the reflux of toluene, the resultant was stirred for two hours, and then the reaction was terminated. Then, the reaction liquid was washed with a saturated salt solution so as to be neutral, and the resultant was dehydrated with anhydrous magnesium sulfate. Thereafter, anhydrous magnesium sulfate was filtered out, and the remainder was concentrated. In this manner, 18.77 g of cage silsesquioxane (mixture) as a target product was obtained. The resultant cage silsesquioxane was a colorless viscous liquid soluble in various organic solvents. A mass analysis was performed after separation of the reactant by means of liquid chromatography after the recondensation reaction. As a result, the silicone resin composition contained about 60% of cage silsesquioxane.

### Synthesis Example 2

To a reaction vessel equipped with a stirrer, a dropping funnel, and a thermometer, 120 ml of IPA as a solvent and 4.0 g of a 5% aqueous solution of TMAH as a basic catalyst were fed. To the dropping funnel, 30 ml of IPA and 10.2 g of vinyltrimethoxysilane were fed. Then, an IPA solution of vinyltrimethoxysilane was dropped over 60 minutes at 0° C. while the mixture in the reaction vessel was stirred. After the dropping, the temperature of the mixture was gradually returned to room temperature, and the mixture was stirred for six hours without being heated. After the stirring, IPA was removed from the solvent under reduced pressure, and the remainder was dissolved into 200 ml of toluene. Subsequently, 20.65 g of the silsesquioxane thus obtained, 82 ml of toluene, and 3.0 g of a 10% aqueous solution of TMAH were fed to a reaction vessel equipped with a stirrer, a dienstag, and a cooling pipe. Thereafter, the mixture was heated to 130° C., and a recondensation reaction of toluene was performed at a reflux temperature. The temperature of a reaction liquid at this time was 108° C. After the reflux of toluene, the resultant was stirred for two hours, and the reaction was terminated. Then, the reaction liquid was washed with a saturated salt solution so as to be neutral, and the resultant was dehydrated with anhydrous magnesium sulfate. Thereafter, anhydrous magnesium sulfate was filtered out, and the remainder was concentrated. In this manner, 18.77 g of cage silsesquioxane (mixture) as a target product was obtained. The resultant cage silsesquioxane was a colorless viscous liquid soluble in various organic solvents. A mass analysis was performed after separation of the reactant by means of liquid chromatography after the recondensation reaction. As a result, the silicone resin composition contained 60% or more of cage silsesquioxane.

(Example of Production of Silica Fine Particles)

A reaction vessel equipped with a stirrer, a thermometer, and a cooling pipe was charged with 100 parts by weight (30 parts by weight of a silica solid content) of isopropanol disperse colloidal silica sol (IPA-ST: produced by Nissan Chemical Industries, Ltd. and having a particle size of 70-100 nm and a solid content of 30 wt %) as silica fine particles and 7 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 68° C., the reaction liquid was additionally heated for five hours, and subjected to a surface treatment, thereby producing silica fine particles. The amount of 3-methacryloxypropyltrimethoxysilane, i.e., 7 parts by weight, was employed in the case of Example 1 in Table 1, which will be described later. In other examples and comparative examples, the amount (parts by weight) of a silane compound with respect to 100 parts by weight of the silica solid content conforms to those shown in Tables 1 and 2 below.

(Example of Production of Silicone Resin Composition Containing Silica Fine Particles)

First, 100 parts by weight of a silicone resin composition were mixed with 100 parts by weight of the solid content of the silica fine particles subjected to the surface treatment with the silane compound, and the mixture was gradually heated under reduced pressure so as to remove a volatilized solvent in the mixture. The final temperature at this time was 80° C. Then, 2.5 parts by weight of 1-hydroxy cyclohexyl phenylketone was added as a photopolymerization initiator, thereby obtaining a transparent silicone resin composition containing silica fine particles.

(Example of Production of Metal Oxide Fine Particles)

Titanium oxide fine particles: a reaction vessel equipped with a stirrer, a thermometer, and a cooling pipe was charged with 100 parts by weight (20 parts by weight of a titanium oxide solid content) of methanoldisperse titanium oxide fine particles (1120Z: produced by JGC Catalysts and Chemicals Ltd., solid content of 20 wt %) as metal oxide fine particles and 5 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 65° C., the reaction liquid was additionally heated for five hours, and subjected to a surface treatment, thereby producing titanium oxide fine particles.

Tin oxide fine particles: a reaction vessel equipped with a stirrer, a thermometer, and a cooling pipe was charged with 100 parts by weight (30 parts by weight of a tin oxide solid content) of 2-propanoldisperse tin oxide (produced by Nissan Chemical Industries, Ltd., solid content of 30 wt %) as metal oxide fine particles and 7 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 82° C., the reaction liquid was additionally heated for five hours, and subjected to a surface treatment, thereby producing tin oxide fine particles.

Zirconia fine particles: a reaction vessel equipped with a stirrer, a thermometer, and a cooling pipe was charged with 100 parts by weight (30 parts by weight of a zirconia solid content) of 2-propanoldisperse zirconia (ZR-30AL: produced by Nissan Chemical Industries, Ltd., solid content of 30 wt %) as metal oxide fine particles and 7 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 82° C., the reaction liquid was additionally heated for five hours, and subjected to a surface treatment, thereby producing zirconia fine particles.

Ceria fine particles: a reaction vessel equipped with a stirrer, a thermometer, and a cooling pipe was charged with 100 parts by weight (30 parts by weight of a ceria solid content) of 2-propanoldisperse ceria (CE-20A: produced by Nissan Chemical Industries, Ltd., solid content of 30 wt %) as metal oxide fine particles and 7 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 82° C., the reaction liquid was additionally heated for five hours, and subjected to a surface treatment, thereby producing ceria fine particles.

Zinc oxide fine particles: a reaction vessel equipped with a stirrer, a thermometer, and a cooling pipe was charged with 100 parts by weight (30 parts by weight of a zinc oxide solid content) of 2-propanoldisperse zinc oxide (F-2: produced by HakusuiTech Co., Ltd., solid content of 30 wt %) as metal oxide fine particles and 7 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 82° C., the reaction liquid was additionally heated for five hours, and subjected to a surface treatment, thereby producing zinc oxide fine particles.

Antimony oxide fine particles: a reaction vessel equipped with a stirrer, a thermometer, and a cooling pipe was charged with 100 parts by weight (20 parts by weight of an oxidation antimony solid content) of 2-propanoldisperse oxidation antimony (CX-Z210IP-F2: produced by Nissan Chemical Industries, Ltd., average particle size of 15 nm, solid content of 20 wt %) as metal oxide fine particles and 5 parts by weight of 3-methacryloxypropyltrimethoxysilane (SZ-6030: produced by Dow Corning Toray Co., Ltd.) as a silane compound. Then, the mixture was gradually heated while being stirred. After the temperature of the reaction liquid had reached 82° C., the reaction liquid was additionally heated for five hours, and subjected to a surface treatment, thereby producing antimony oxide fine particles.

The amount (parts by weight) of the silane compound with respect to 100 parts by weight of a metal oxide solid content conforms to those shown in Tables 1 and 2 below.

(Example of Production of Silicone Resin Composition Containing Metal Oxide Fine Particles)

First, 100 parts by weight of the solid content of the metal oxide fine particles subjected to the surface treatment with the silane compound was mixed with 100 parts by weight of a silicone resin composition, and the mixture was gradually heated under reduced pressure so as to remove a volatile solvent in the mixture. The final temperature at this time was 80° C. Then, 2.5 parts by weight of 1-hydroxy cyclohexyl phenylketone was added as a photopolymerization initiator, thereby obtaining a transparent silicone resin composition containing metal oxide fine particles.

(Example of Production of Transparent Layered Structure)

As a transparent resin base, polycarbonate (L-1250: produced by Teijin Chemicals Ltd.) or polymethyl methacrylate (produced by KANEKA CORPORATION) was used. First, a spacer was bonded to a transparent resin base having a substantially uniform thickness of 3 mm such that the transparent protective film has a predetermined thickness. Then, a coating composition constituting a transparent protective film including 2.5 parts of 1-hydroxy cyclohexyl phenylketone as a photopolymerization initiator was casted, and the base was heated at 80° C. for three minutes. The base was then pressed with a PET film so that an unnecessary part of the coating composition was removed. Thereafter, while the base being covered with the PET film, the base was irradiated with light with a mercury lamp under conditions that the illuminance in the wavelength range from 200 nm to 400 nm, both inclusive, is 505 mW/cm²), and was cured with a cumulative exposure of 8400 mJ/cm², thereby providing a transparent protective film.

(Example of Production of Transparent Layered Structure Including Transparent Primer Layer)

As a transparent resin base, polycarbonate (L-1250: produced by Teijin Chemicals Ltd.) was used. First, a coating composition constituting a transparent protective film including 2.5 parts of 1-hydroxy cyclohexyl phenylketone as a photopolymerization initiator was casted on a PET film, and an unnecessary part of the coating composition was removed with a blade. Then, a spacer was bonded to the transparent resin base such that the transparent primer layer has a predetermined thickness, and a coating composition for a transparent primer layer was casted, and heated at 80° C. for three minutes. Thereafter, the transparent resin base to which the coating composition for a transparent primer layer was attached was pressed with a PET film to which the coating composition for a transparent protective film was attached, and a coating composition to be an unnecessary part of a transparent primer layer was removed. Subsequently, while being covered with the PET film, the base was irradiated with light with a mercury lamp under conditions that the illuminance in the wavelength range from 200 nm to 400 nm, both inclusive, was 505 mW/cm², and was cured with a cumulative exposure of 8400 mJ/cm², thereby providing a transparent primer layer and a transparent protective film. In this manner, a transparent layered structure was obtained.

Table 1 below shows materials of a transparent resin base and the composition and thickness of a transparent protective film of a transparent layered structure including no transparent primer layer in examples and comparative examples.

TABLE 1

| | | | Example | | | | | | | | | | | | | | |
|---|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 | 15 |
| Trans- | Base resin | | S1 | | | S1 | | | | | | S1 | | | | | S2 |
| parent | (Thickness 3 mm) | | | | | | | | | | | | | | | | |
| resin | | | | | | | | | | | | | | | | | |
| base | | | | | | | | | | | | | | | | | |
| Trans- | Curing | A | 25 | | | 25 | | | | | | 25 | 15 | 20 | 100 | — | 25 |
| parent | resin | B | — | | | — | | | | | | — | — | — | — | 100 | — |
| protec- | (parts | C | — | | | — | | | | | | — | — | 60 | — | — | — |
| tive | by | D | 65 | | | 65 | | | | | | 65 | 75 | — | — | — | 65 |
| film | weight)* | E | 10 | | | 10 | | | | | | 10 | 10 | 10 | — | — | 10 |
| | | F | — | | | — | | | | | | — | — | 10 | — | — | — |
| | | G | — | | | — | | | | | | — | | | | | — |
| | | H | — | | | — | | | | | | — | | | | | — |
| | | I | — | | | — | | | | | | — | | | | | — |
| | Cage silsesquioxane | | 15% | | | 15% | | | | | | 15% | 9% | 12% | 60% | 60% | 15% |
| | percentage (wt %)* | | | | | | | | | | | | | | | | |
| | Photopolymerization | | 2.5 | | | 2.5 | | | | | | 2.5 | | | | | 2.5 |
| | initiator (parts by | | | | | | | | | | | | | | | | |
| | weight)* | | | | | | | | | | | | | | | | |
| | Curing catalyst | | — | | | — | | | | | | — | | | | | — |
| | (parts by weight)* | | | | | | | | | | | | | | | | |
| | Glass fine | P-1(23) | 25 | | | — | 400 | — | — | — | — | 50 | | | | | 25 |
| | particles/ | P-2(0.1) | — | | | — | | | | | | — | | | | | — |
| | metal | P-2(15) | | | | — | — | 100 | — | — | — | — | | | | | |
| | oxide | P-2(23) | | | | 5 | — | — | 100 | — | — | 50 | | | | | |
| | fine | P-2(50) | | | | — | — | — | — | 100 | — | — | | | | | |
| | particles | P-2(80) | | | | — | — | — | — | — | 100 | — | | | | | |
| | (parts | P-2(90) | | | | — | | | | | | — | | | | | |
| | by | P-3(25) | — | | | — | | | | | | — | | | | | — |
| | weight)* | P-4(23) | | | | | | | | | | | | | | | |
| | | P-5(23) | | | | | | | | | | | | | | | |
| | | P-6(23) | | | | | | | | | | | | | | | |
| | | P-7(23) | | | | | | | | | | | | | | | |
| | | P-8(25) | | | | | | | | | | | | | | | |

| | Thickness (μm) | 10 | 30 | 80 | 30 | | | | | | 30 | | | | | 30 |
|---|---|---|---|---|---|---|---|---|---|---|---|---|---|---|---|---|
| Evalu- | Initial appearance | ◯ | | | ◯ | | | | | | ◯ | | | | | ◯ |
| ation | Scratch resistance | 80 | 86 | 83 | 90 | 75 | 71 | 75 | 72 | 70 | 82 | 75 | 82 | 81 | 83 | 88 |
| | Abrasion resistance | 6 | 6 | 6 | 9 | 5 | 2 | 3 | 5 | 9 | 4 | 8 | 4 | 2 | 2 | 5 |

| Soil resistance | ◯ | ◯ | | | ◯ | ◯ |
|---|---|---|---|---|---|---|
| Degree of privacy | 1.49 | 1.49 | 1.46 | 1.48 | 1.48 | 1.49 |

| | | | | | | | | | | | Comparative | | | | |
|---|---|---|---|---|---|---|---|---|---|---|---|---|---|---|---|
| | | | Example | | | | | | | | example | | | | |
| | | | 16 | 17 | 18 | 19 | 20 | 21 | 22 | 23 | 1 | 2 | 3 | 4 | 5 |
| Trans- | Base resin | | S1 | | | | | | S1 | | S1 | | S1 | | |
| parent | (Thickness 3 mm) | | | | | | | | | | | | | | |
| resin | | | | | | | | | | | | | | | |
| base | | | | | | | | | | | | | | | |
| Trans- | Curing | A | 25 | | | | | | — | | 25 | | 25 | | |
| parent | resin | B | — | | | | | | — | | — | | — | | |
| protec- | (parts | C | — | | | | | | — | | — | | — | | |
| tive | by | D | 65 | | | | | | — | | 65 | | 65 | | |
| film | weight)* | E | 10 | | | | | | — | | 10 | | 10 | | |
| | | F | — | | | | | | — | | — | | — | | |
| | | G | — | | | | | | 70 | | — | | — | | |
| | | H | — | | | | | | 5 | | — | | — | | |
| | | I | — | | | | | | 25 | | — | | — | | |
| | Cage silsesquioxane | | 15% | | | | | | 15% | | 15% | | 15% | | |
| | percentage (wt %)* | | | | | | | | | | | | | | |
| | Photopolymerization | | 2.5 | | | | | | — | | 2.5 | | 2.5 | | |
| | initiator (parts by | | | | | | | | | | | | | | |
| | weight)* | | | | | | | | | | | | | | |
| | Curing catalyst | | — | | | | | | 2.5 | | — | | — | | |
| | (parts by weight)* | | | | | | | | | | | | | | |
| | Glass fine | P-1(23) | — | | | | | | — | | 25 | | — | | |
| | particles/ | P-2(0.1) | | | | | | | — | | — | | — | 100 | — |
| | metal | P-2(15) | | | | | | | — | | | | — | | |
| | oxide | P-2(23) | | | | | | | 100 | | | | | | |
| | fine | P-2(50) | | | | | | | — | | | | | | |
| | particles | P-2(80) | | | | | | | — | | | | | | |
| | (parts | P-2(90) | | | | | | | — | | | | — | — | 100 |
| | by | P-3(25) | 100 | — | — | — | — | — | — | | — | | — | | |
| | weight)* | P-4(23) | — | 100 | — | — | — | — | | | | | | | |
| | | P-5(23) | — | — | 100 | — | — | — | | | | | | | |
| | | P-6(23) | — | — | — | 100 | — | — | | | | | | | |
| | | P-7(23) | — | — | — | — | 100 | — | | | | | | | |
| | | P-8(25) | — | — | — | — | — | 100 | | | | | | | |

| | Thickness (μm) | 30 | | | | | | 30 | 80 | 5 | 200 | 30 | | |
|---|---|---|---|---|---|---|---|---|---|---|---|---|---|---|
| Evalu- | Initial appearance | ◯ | | | | | | ◯ | | ◯ | | ◯ | | |
| ation | Scratch resistance | 76 | 73 | 77 | 72 | 71 | 72 | 78 | 79 | 42 | 61 | 96 | 32 | 67 |
| | Abrasion resistance | 3 | 4 | 2 | 5 | 5 | 5 | 8 | 8 | 7 | 8 | 16 | 8 | 9 |

| | | | | | | | | | | |
|---|---|---|---|---|---|---|---|---|---|---|
| Soil resistance | ◯ | ⊚ | ◯ | ◯ | ◯ | ⊚ | ◯ | ◯ | ◯ | ◯ |

| | | | | | | | | | |
|---|---|---|---|---|---|---|---|---|---|
| Degree of privacy | 1.73 | 1.57 | 1.65 | 1.58 | 1.57 | 1.58 | 1.48 | 1.49 | 1.48 |

Table 2 below shows materials of a transparent resin base, the composition and thickness of a transparent primer layer, and the composition of a transparent protective film in a transparent layered structure including the transparent primer layer in examples and comparative examples.

TABLE 2

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Trans- | Base resin | | S1 | | | | | | S1 | | | | | S1 | |
| parent | (Thickness 3 mm) | | | | | | | | | | | | | | |
| resin | | | | | | | | | | | | | | | |
| base | | | | | | | | | | | | | | | |
| Trans- | Acrylic resin | PA | 50 | 50 | 10 | 100 | 50 | 50 | 50 | | | | | 50 | |
| parent | composition | PB | 50 | 50 | 90 | — | 50 | 50 | 50 | | | | | 50 | |
| primer | (parts by | PC | — | | | | | | — | | | | | — | |
| layer | weight)* | | | | | | | | | | | | | | |
| | Photopolymerization | | 2.5 | | | | | | 2.5 | | | | | 2.5 | |
| | initiator (parts by | | | | | | | | | | | | | | |
| | weight)* | | | | | | | | | | | | | | |
| | UV absorber | UV1 | — | | | | | | 2 | — | — | — | — | — | |
| | (parts by | UV2 | — | | | | | | — | — | — | — | 2 | — | |
| | weight)* | UV3 | 2 | | | | | | — | 2 | 2 | 2 | — | 2 | |
| | Light stabilizer | | 1 | | | | | | 1 | | | | | 1 | |
| | (parts by weight)* | | | | | | | | | | | | | | |
| | Thickness (μm) | | 5 | 50 | 20 | 20 | 20 | 20 | 50 | | | | | 50 | |
| Trans- | Curing resin | A | 25 | | | | 20 | 25 | 25 | | | | 15 | 25 | |
| parent | (parts by | C | — | | | | 60 | — | — | | | | — | — | |
| protec- | weight)* | D | 65 | | | | — | 65 | 65 | | | | 75 | 65 | |
| tive | | E | 10 | | | | 10 | 10 | 10 | | | | 10 | 10 | |
| film | | F | — | | | | 10 | — | — | | | | — | — | |
| | | G | — | | | | — | — | — | | | | — | — | |
| | | H | — | | | | — | — | — | | | | — | — | |
| | | I | — | | | | — | — | — | | | | — | — | |
| | Cage silsesquioxane | | 15% | | | | 12% | 15% | 15% | | | | 9% | 15% | |
| | percentage (wt %)* | | | | | | | | | | | | | | |
| | Photopolymerization | | 2.5 | | | | | | 2.5 | | | | | 2.5 | |
| | initiator (parts by | | | | | | | | | | | | | | |
| | weight)* | | | | | | | | | | | | | | |
| | Curing catalyst | | — | | | | | | — | | | | | — | |
| | (parts by weight)* | | | | | | | | | | | | | | |
| | Glass fine | P-1(23) | — | | | | | | — | 400 | — | — | — | — | |
| | particles/ | P-2(15) | — | | | | | | — | — | 100 | — | — | | |
| | metal | P-2(23) | 100 | | | | | | 5 | — | — | — | 50 | | |
| | oxide fine | P-2(80) | — | | | | | | — | — | — | 100 | — | | |
| | particles | P-3(25) | — | | | | | | — | | | | | 100 | — |
| | (parts by | P-4(23) | | | | | | | | | | | | — | 100 |
| | weight)* | P-5(23) | | | | | | | | | | | | — | — |
| | | P-6(23) | | | | | | | | | | | | — | — |
| | | P-7(23) | | | | | | | | | | | | — | — |
| | | P-8(25) | | | | | | | | | | | | — | — |

| | Thickness (μm) | 5 | 5 | 10 | 10 | 10 | 80 | 30 | | | | | 30 | |
|---|---|---|---|---|---|---|---|---|---|---|---|---|---|---|
| Evalu- | Initial appearance | ◯ | | | | | | ◯ | | | | | ◯ | |
| ation | Scratch resistance | 78 | 80 | 81 | 73 | 84 | 76 | 91 | 79 | 75 | 72 | 78 | 76 | 72 |
| | Abrasion resistance | 4 | 4 | 5 | 5 | 3 | 3 | 9 | 3 | 2 | 8 | 7 | 4 | 4 |

| | | | | |
|---|---|---|---|---|
| Weather | 200 MJ/m² | ◯ | ◯ | ◯ |
| resistance | 600 MJ/m² | ◯ | ◯ | ◯ |

| Soil resistance | ◯ | ◯ | | | | ◯ | ⊚ |
|---|---|---|---|---|---|---|---|
| Degree of privacy | 1.48 | 1.49 | 1.46 | 1.48 | 1.48 | 1.73 | 1.57 |

| | | | | | | Comparative | |
|---|---|---|---|---|---|---|---|
| Example | | | | | | example | |
| 14 | 15 | 16 | 17 | 18 | 19 | 1 | 2 |

| Trans- | Base resin | | S1 | S1 | S1 | |
|---|---|---|---|---|---|---|
| parent | (Thickness 3 mm) | | | | | |
| resin | | | | | | |
| base | | | | | | |
| Trans- | Acrylic resin | PA | 50 | — | 50 | 50 |
| parent | composition | PB | 50 | — | 50 | 50 |
| primer | (parts by | PC | — | 100 | — | |
| layer | weight)* | | | | | |
| | Photopolymerization | | 2.5 | — | 2.5 | |
| | initiator (parts by | | | | | |
| | weight)* | | | | | |
| | UV absorber | UV1 | — | — | 2 | 2 |
| | (parts by | UV2 | — | — | — | — |
| | weight)* | UV3 | 2 | 2 | — | — |
| | Light stabilizer | | 1 | 1 | 1 | 1 |
| | (parts by weight)* | | | | | |
| | Thickness (μm) | | 50 | 10 | 5 | 1 |
| Trans- | Curing resin | A | 25 | — | 25 | 25 |
| parent | (parts by | C | — | — | — | — |
| protec- | weight)* | D | 65 | — | 65 | 65 |
| tive | | E | 10 | — | 10 | 10 |
| film | | F | — | — | — | — |
| | | G | — | 70 | — | — |
| | | H | — | 5 | — | — |
| | | I | — | 25 | — | — |

| Cage silsesquioxane | | 15% | | | | 15% | 15% | |
|---|---|---|---|---|---|---|---|---|
| percentage (wt %)* | | | | | | | | |
| Photopolymerization | | 2.5 | | | | — | 2.5 | 2.5 |
| initiator (parts by | | | | | | | | |
| weight)* | | | | | | | | |
| Curing catalyst | | — | | | | 2.5 | — | |
| (parts by weight)* | | | | | | | | |
| Glass fine | P-1(23) | — | | | | — | — | 100 |
| particles/ | P-2(15) | | | | | — | — | — |
| metal oxide | P-2(23) | | | | | 100 | — | 100 |
| fine | P-2(80) | | | | | — | — | — |
| particles | P-3(25) | — | — | — | — | — | — | — |
| (parts by | P-4(23) | — | — | — | — | | — | — |
| weight)* | P-5(23) | 100 | — | — | — | | — | — |
| | P-6(23) | — | 100 | — | — | | — | — |
| | P-7(23) | — | — | 100 | — | | — | — |
| | P-8(25) | — | — | — | 100 | | — | — |

| | Thickness (μm) | 30 | | | | 30 | 80 | 10 | 10 |
|---|---|---|---|---|---|---|---|---|---|
| Evalu- | Initial appearance | ◯ | | | | ◯ | | ◯ | ◯ |
| ation | Scratch resistance | 79 | 75 | 71 | 73 | 79 | 79 | 82 | 80 |
| | Abrasion resistance | 5 | 7 | 6 | 4 | 9 | 8 | 15 | 6 |

| | | | | | |
|---|---|---|---|---|---|
| Weather | 200 MJ/m² | ◯ | ◯ | ◯ | ◯ |
| resistance | 600 MJ/m² | ◯ | ◯ | ◯ | Yellowing |
| | | | | | Crack |

| | | | | | | | | |
|---|---|---|---|---|---|---|---|---|
| Soil resistance | ◯ | ◯ | ◯ | ⊚ | ◯ | ◯ | ◯ | ◯ |

| | | | | | | | |
|---|---|---|---|---|---|---|---|
| Degree of privacy | 1.65 | 1.58 | 1.57 | 1.58 | 1.48 | 1.49 | 1.47 |

In Tables 1 and 2, characters denote the followings materials:

### Base Resin

S1: polycarbonate (PC) (L-1250: produced by Teijin Chemicals Ltd.)

S2: polymethyl methacrylate (PMMA) (produced by KANEKA CORPORATION)

### Silicone Resin Composition (Curing Resin)

A: Compound obtained by Synthesis Example 1 (acryloyl group)

B: Compound obtained by Synthesis Example 2 (vinyl group)

C: 1,3,5-tris(3-mercapto butyloxyethyl)-1,3,5-triazine-2,4,6(1H,3H,5H)triione (Karenz MT-NR1: produced by Showa Denko K.K.)

D: trimethylolpropane triacrylate

E: dipentaerythritol hexaacrylate

F: diallyl maleate

G: octakis[[3-(2,3-epoxypropoxyl)propyl)]dimethylsiloxy]octasilsesquioxane (Q-4: produced by Mayaterials)

H: 1,4-cyclohexanedimethanoldiglycidyl ether (RIKARESIN DME-100: produced by New Japan Chemical Co., Ltd.)

I: 1,2,4,5-cyclohexanetetracarboxylic dianhydride (produced by Tokyo Chemical Industry Co., Ltd.)

### UV Absorber

UV1-UV3: hydroxyphenyltriazine-based UV absorber (TINUVIN400, TINUVIN477, and TINUVIN479: produced by BASF Japan Ltd.)

### Light Stabilizer

hindered amine-based light stabilizer (TINUVIN123: produced by BASF Japan Ltd.)

### Silica Fine Particles

P1: isopropanol disperse colloidal silica (IPA-ST: produced by Nissan Chemical Industries, Ltd., particle size of 10-15 nm)

P2: isopropanol disperse colloidal silica (IPA-ST-ZL: produced by Nissan Chemical Industries, Ltd., particle size of 70-100 nm)

### Metal Oxide Fine Particles

P3: methanoldisperse titanium oxide (1120Z: produced by JGC Catalysts and Chemicals Ltd., average particle size of 13 nm)

P4: 2-propanoldisperse tin oxide (CX-S303IP produced by Nissan Chemical Industries, Ltd., particle size 5-20 nm)

P5: 2-propanoldisperse zirconia (ZR-30AL: produced by Nissan Chemical Industries, Ltd., average particle size 91 nm)

P6: 2-propanoldisperse ceria (CE-20A: produced by Nissan Chemical Industries, Ltd., particle size 8-12 nm)

P7: 2-propanoldisperse zinc oxide (F-2: produced by HakusuiTech Co., Ltd., average particle size of 65 nm)

P8: 2-propanoldisperse oxidation antimony (CX-Z210IP-F2: produced by Nissan Chemical Industries, Ltd., average particle size of 15 nm)

### Acrylic Resin Composition (Only in Table 2)

PA: dicyclopentenyl diacrylate (Light Acrylate DCP-A: produced by Kyoeisha Chemical Co., Ltd.)

PB: PEG400#diacrylate (Light Acrylate 9EG-A: produced by Kyoeisha Chemical Co., Ltd.)

PC: acrylic copolymer C

The base S1 has a heat resistance to 140° C. (JIS K7191 B) and also has an elastic modulus of 2.2 gPa at room temperature and a Vickers hardness of 13 kgf/mm² at room temperature. Similarly, the base S2 has a heat resistance to 100° C. (JIS K7191 B) and also has an elastic modulus of 3.1 GPa at room temperature and a Vickers hardness of 20 kgf/mm² at room temperature.

The silica fine particles P1 have a particle size of greater than or equal to 10 nm and less than or equal to 15 nm, and the silica fine particles P2 have a particle size greater than or equal to 70 nm and less than or equal to 100 nm as described above. It should be noted that the particle size has a variation, and thus, it is difficult to measure the particle sizes of all the fine particles. For this reason, the transparent protective film can include silica fine particles whose particle sizes are not in the above ranges.

The metal oxide fine particles P3 have an average particle size of 13 nm. The metal oxide fine particles P4 have a particle size greater than or equal to 5 nm and less than or equal to 20 nm. The metal oxide fine particles P5 have an average particle size of 91 nm. The metal oxide fine particles P6 have a particle size greater than or equal to 8 nm and less than or equal to 12 nm. The metal oxide fine particles P7 have an average particle size of 65 nm. The metal oxide fine particles P8 has an average particle size of 15 nm as described above. It should be noted that the particle size has a variation, and thus, it is difficult to measure the particle sizes of all the fine particles. For this reason, the transparent protective film can include metal oxide fine particles whose particle sizes are not in the above ranges.

Among the silicone resin compositions A-I shown in Tables 1 and 2, the compounds A and B obtained in Synthesis Examples 1 and 2 include cage silsesquioxane. As described above, each of the compounds A and B includes about 60% of cage silsesquioxane. In view of this, “cage silsesquioxane percentage (wt %)” in Tables 1 and 2 shows the cage silsesquioxane percentage in the silicone resin composition.

In Tables 1 and 2, “silica fine particles/metal oxide fine particles (parts by weight)” indicates the amount (parts by weight) of a silica solid content or a metal oxide solid content in a transparent layered structure, and parenthesized numerals indicate the amount (parts by weight) of a silane compound with respect to 100 parts by weight of the silica solid content or the metal oxide solid content.

In Tables 1 and 2, values of the composition provided with * (asterisk) indicates the value when prepared.

Tables 1 and 2 show evaluation results of tests on transparent layered structures obtained by examples and comparative examples.

The tests were conducted in the following manner.

Initial appearance: appearances of transparent layered structures 1 and 51 before the tests were visually observed. When neither cracks nor flakes occurred in the transparent layered structures 1 and 51, the test was determined as “∘.”

Scratch resistance test: the tests were conducted with a test device for measuring a scratch resistance illustrated in FIG. 10. A scratcher 14 covered with cotton and attached to a load applying arm 13 was moved forward and backward in the directions indicated by arrow A with dust D interposed between the scratcher 14 and a test specimen G. The tests were conducted under conditions that the load applied from the load applying arm 13 was 2N, the travel distance of the scratcher 14 was 120 mm, the reciprocation speed was 0.5 times/s, and the ambient temperature was 20° C. The dust D was a particle group including silica particles and alumina particles both having an average particle size of 300 μm or less. The values of the scratch resistance shown in Tables 1 and 2 indicate surface gloss values after a predetermined number of reciprocations in a case where a surface gloss value before the test was 100. The surface gloss values were calculated based on the strength of reflected light received by a light receiver 22 when the specimen G is irradiated with illuminating light from a light source 21 by using a measurement device illustrated in FIG. 11. It is determined that a high scratch resistance is obtained when the gloss retention percentage (i.e., surface gloss value after test/surface gloss value before test) exceeds 70%.

A taper abrasion test: an abrasion resistance test was conducted in accordance with JIS R 3212, and a frosted value (%) of a transparent layered structure after 500 rotations of an abrasion disc were measured. Values in Table 1 each indicate a value of (frosted value after test)−(frosted value before test). It was determined that a high abrasion resistance was obtained when the frosted value variation between a value before a test and a value after the test was less than 10%.

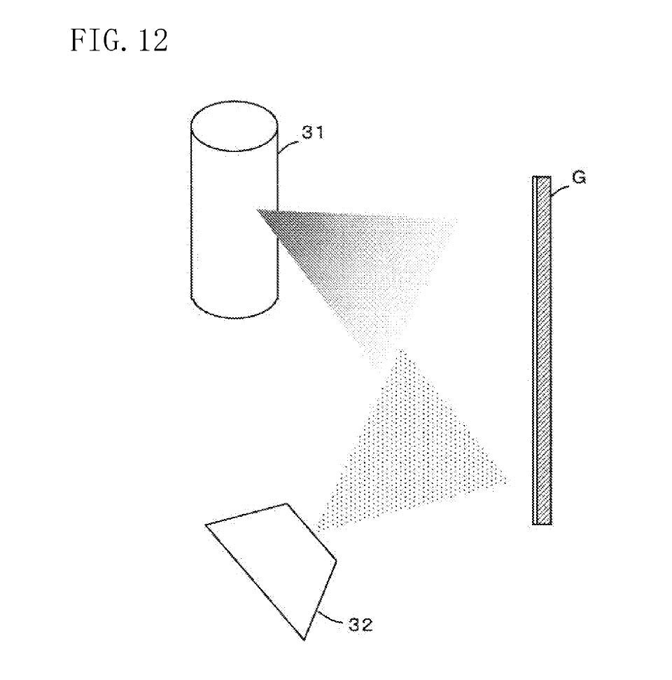

Weather resistance test: as illustrated in FIG. 12, light with an illuminance of 180 W/m² was applied for 60 minutes with a weather resistance test device equipped with a xenon light source 31 and a sprinkler 32 under conditions that (1) a black-panel temperature was 73° C. and a humidity was 35%. Then, light with an illuminance of 180 W/m² was applied for 80 minutes under conditions that (2) the black-panel temperature was 50° C. and the humidity was 95%. The conditions (1) and (2) were defined as one cycle, and this cycle was repeated. Cumulative amounts of the illuminating light were 200 mJ/m² and 600 mJ/m² (Table 2). Changes in appearance of the transparent layered structures 1 and 51 were visually observed. If neither cracks nor color change was observed, the result was determined to be “∘ (single circle).”

Soil resistant test: the transparent layered structures 1 and 51 were placed outdoors at an angle of 30° relative to the horizontal plane and exposed to the outdoors for 30 days, and then changes in transparency of the transparent layered structures 1 and 51 were visually observed. After the exposure, if the transparency of the transparent layered structures 1 and 51 was sufficiently kept without any treatment, the test result was determined to be “⊚ (double circle),” whereas if the transparency of the transparent layered structures 1 and 51 was sufficiently kept after washing, the test result was determined to be “∘.”

Degree of privacy: refractive indexes of protective film portions of the transparent layered structures 1 and 51 deposited on a glass plate instead of a base resin were measured with a refractometer by a critical angle method. A higher refractive index makes it more difficult to see the inside of a cabin from outside the vehicle, and thus, provides a higher degree of privacy, than a lower refractive index.

First, test results shown in Table 1 (with no transparent primer layer) will be described.

In Examples 1-3 and Comparative Examples 1 and 2, tests were conducted under the same conditions except the thickness of the transparent protective film. When the thickness of the transparent protective film was in the range from 10 μm and 80 μm, both inclusive (Examples 1-3), the gloss retention percentage exceeded 70%, and the frosted value variation was below 10%. On the other hand, in Comparative Examples 1 and 2 in which the thickness of the transparent protective film was 5 μm and 200 μm, the gloss retention percentage was below 70%. These results show that a high abrasion resistance and a high scratch resistance can be obtained when the thickness of the transparent protective film is in the range from 10 μm and 80 μm, both inclusive.

On the other hand, in Comparative Example 3 including a transparent protective film including no silica fine particles and having a thickness of 30 μm, the gloss retention percentage exceeded 70%, but the frosted value variation greatly exceeded 10%. This results show that a sufficiently high abrasion resistance cannot be obtained when the transparent protective film includes no silica fine particles.

In Examples 6-9 and Comparative Examples 4 and 5, tests were conducted under the same conditions except the weight proportion of the silane compound including surface-treated silica fine particles. When the weight proportion was 15 wt % to 80 wt % (i.e., in Examples 6-9), the gloss retention percentage exceeded 70%, and the frosted value variation was below 10%. On the other hand, when the weight proportion of the silane compound was 0.1 wt % and 90 wt % (i.e., in Comparative Examples 4 and 5), the gloss retention percentage was below 70%, and the frosted value variation exceeded 10%. These results show that with a surface treatment performed such that the weight proportion of the silane compound was greater than or equal to 15 wt % and less than or equal to 80 wt % with respect to silica fine particles, a high abrasion resistance and a high scratch resistance can be obtained.

In Examples 10-14 in which tests were conducted with a change in cage silsesquioxane percentage of the silicone resin composition (to 9% or more), the gloss retention percentage also exceeded 70%, and the frosted value variation was below 10%. The percentage of cage silsesquioxane was about 60% at maximum (Examples 13 and 14) among the examples. However, when the percentage is higher than 60%, a high abrasion resistance and a scratch resistance can also be obtained. In Example 15 in which the base resin was changed to polymethyl methacrylate, the gloss retention percentage also exceeded 70%, and the frosted value variation was also below 10%. Thus, it can be concluded that a high abrasion resistance and a high scratch resistance can be obtained when tests are conducted with a change of the base resin to polymethyl methacrylate under the conditions of the examples.

In Examples 16-21 in which silica fine particles were changed to metal oxide fine particles, the gloss retention percentage also exceeded 70%, and the frosted value variation was also below 10%.

In Examples 22 and 23, polycarbonate (L-1250: produced by Teijin Chemicals Ltd.) was used as a transparent resin base. First, a spacer was bonded to a transparent resin base having a substantially uniform thickness of 3 mm such that the transparent protective film has a predetermined thickness. Then, a coating composition constituting a transparent protective film including 2.5 parts of phthalimide DBU (produced by Tokyo Chemical Industry Co., Ltd.) as a curing catalyst was casted, and the base was heated at 80° C. for three minutes. Thereafter, an unnecessary part of the coating composition was removed with a coater blade. Subsequently, the base was heated at 120° C. for one hour to be cured, a transparent protective film was provided, thereby forming a transparent layered structure.

In Examples 22 and 23, the gloss retention percentage also exceeded 70%, and the frosted value variation was also below 10%.

In Examples 1-23, the transparent protective film includes 5 or more parts by weight of, and 400 parts or less by weight of, silica fine particles or metal oxide fine particles with respect to 100 parts by weight of the silicone resin composition. In these examples, the gloss retention percentage exceeds 70%, and the frosted value variation was below 10%. The results show that a high abrasion resistance and a high scratch resistance can be obtained when the transparent protective film includes 5 or more parts by weight of, and 400 parts or less by weight of, silica fine particles or metal oxide fine particles with respect to 100 parts by weight of the silicone resin composition.

In these examples and comparative examples in which the thickness of the transparent protective film was greater than or equal to 5 μm and less than or equal to 200 μm, no cracks occurred in initial appearance. Although not shown in Table 1, a weather resistance test (200 mJ/m²) assuming the use under severe environments was conducted on a transparent layered structure used in each of the examples and the comparative examples. In this test, neither cracks nor yellowing occurred in any of the transparent layered structures. Thus, the transparent layered structures of the examples achieved high weather resistances.

In Examples 1-23, high soil resistances and high degrees of privacy were obtained, and especially in Examples 16-21, higher soil resistances and higher degrees of privacy were obtained.

Next, test results in Table 2 (with transparent primer layers) will be described.

In Examples 18 and 19, a flask equipped with a reflux condenser and a stirrer and subjected to nitrogen substitution was charged with a mixture of 80.1 parts of methyl methacrylate, 13 parts of 2-hydroxyethyl methacrylate, 0.14 parts of azobisisobutyronitrile, and 200 parts of 1,2-dimethoxyethane. Then, the mixture was dissolved. Thereafter, the mixture was stirred in an nitrogen stream at 70° C. for six hours to be reacted. The resultant reaction solution was added to n-hexane for re-precipitation and purification, thereby obtaining 80 parts of acrylic copolymer C.

Subsequently, 8.9 of the acrylic copolymer C thus obtained, 2 parts of a hydroxyphenyltriazine-based UV absorber (TINUVIN479: produced by BASF Japan Ltd.) and one part of a hindered amine-based light stabilizer (TINUVIN123: produced by BASF Japan Ltd.) were dissolved in a mixed solvent including 20 parts of methyl ethyl ketone, 30 parts of methyl isobutyl ketone, and 30 parts of 2-propanol. Then, 1.1 parts of hexamethylene diisocyanate was added to the solution such that 1.5 equivalent weights of an isocyanate group is included with respect to one equivalent weight of a hydroxy group of the acrylic copolymer C. The mixture was stirred at 25° C. for five minutes, thereby preparing a coating composition.

In Examples 18 and 19, polycarbonate (L-1250: produced by Teijin Chemicals Ltd.) was used as a transparent resin base. First, a spacer was bonded to a transparent resin base such that a transparent primer layer has a predetermined thickness. Then, a coating composition for a transparent primer layer was casted, and was allowed to stand at 80° C. for three minutes. Subsequently, the coating composition was heated at 120° C. for one hour to be cured, thereby providing a transparent primer layer. Thereafter, a spacer was bonded to the transparent primer layer such that a transparent protective film has a predetermined thickness. Then, a coating composition for a transparent protective film and including 2.5 parts of phthalimide DBU (produced by Tokyo Chemical Industry Co., Ltd.) as a curing catalyst was casted, and heated at 80° C. for three minutes. Thereafter, an unnecessary part of the coating composition was removed with a coater blade. Subsequently, the base was heated at 120° C. for one hour to be cured, and a transparent protective film was provided. In this manner, a transparent layered structure was obtained.

In examples in Table 2 in which the thickness of the transparent layered structure is greater than or equal to 5 μm and less than or equal to 80 μm, and the transparent protective film includes 5 or more parts by weight of, and 400 or less parts by weight of, silica fine particles or metal oxide fine particles with respect to 100 parts by weight of the silicone resin composition, the gloss retention percentage exceeded 70%, and the frosted value variation was below 10%. The results show that a high abrasion resistance and a high scratch resistance were obtained in these examples in a manner similar to the examples shown in Table 1. In Comparative Example 1 shown in Table 1 (with no transparent primer layer), when the thickness of the transparent protective film was 5 μm, the gloss retention percentage was significantly below 70%. On the other hand, in Examples 1 and 2 shown in Table 2, the gloss retention percentage exceeded 70%. This seems to be because the transparent primer layer supports part of the anti-crack function of the transparent protective film.

As shown in Table 2, in these example, the silica fine particles or the metal oxide fine particles were subjected to a surface treatment such that the weight proportion of the silane compound was greater than or equal to 15 wt % and less than or equal to 80 wt %. It can be concluded that a high abrasion resistance and a high scratch resistance were obtained in this range.

In the examples and the comparative examples in which the thickness of the transparent protective film was greater than or equal to 5 μm and less than or equal to 80 μm, no cracks occurred in initial appearance. In a weather resistance test (cumulative amount of illuminating light: 200 mJ/m²) assuming the use under severe environments, neither cracks nor yellowing occurred in the transparent layered structures of all the examples and comparative examples. Thus, the transparent layered structures of the examples achieve high weather resistances.

In the examples in which the thickness of the transparent primer layer was greater than or equal to 5 μm, neither cracks nor yellowing occurred in a weather resistance test assuming the use of severe environments in a long period and having an increased cumulative amount of illuminating light to 600 mJ/m². Thus, when the thickness of the transparent primer layer is greater than or equal to 5 μm, a higher weather resistance can be obtained.

The transparent primer layers of the transparent layered structures of the example and comparative examples include different types of UV absorbers. Similar results are expected to be obtained for weather resistance tests in the case of changing the type of UV absorbers. If the transparent primer layer does not include an UV absorber, similar results are expected to be obtained.

In Examples 1-19, high soil resistances and high degrees of privacy were obtained. In Examples 12-17, higher soil resistances and higher degrees of privacy were obtained.

In Table 2, tests were conducted by using polycarbonate as a base resin. Based on the results shown in Table 1, it is clear that similar results are obtained when the base resin is polymethyl methacrylate.

### INDUSTRIAL APPLICABILITY

The present invention is widely applicable to window materials for mobile objects such as vehicle window materials and other window materials.

### DESCRIPTION OF REFERENCE CHARACTERS

1, 51: transparent layered structure 2, 52: transparent resin base 3, 53: transparent protective film 4, 54: fine particles 55: transparent primer layer

1. A transparent layered structure comprising:
a plate-like transparent resin base; and
a transparent protective film located on at least one surface of the transparent resin base, wherein
the transparent resin base has a heat resistance to temperatures greater than or equal to 70° C.,
the transparent protective film has a thickness greater than or equal to 10 μm and less than or equal to 80 μm, and includes a silicone resin composition including 9 wt % or more of cage silsesquioxane and fine particles constituted by glass fine particles or metal oxide fine particles subjected to a surface treatment with a silane compound and having a particle size greater than or equal to 10 nm and less than or equal to 100 nm,
the fine particles have a weight proportion greater than or equal to 5 parts by weight and less than or equal to 400 parts by weight with respect to 100 parts by weight of the silicone resin composition, and
the silane compound has a weight proportion greater than or equal to 15 wt % and less than or equal to 80 wt % with respect to the fine particles.

2. The transparent layered structure of claim 1, wherein
the transparent resin base includes polycarbonate resin or acrylic resin, and has a substantially uniform thickness greater than or equal to 1 mm, an elastic modulus greater than or equal to 1 GPa at room temperature, and a Vickers hardness greater than or equal to 10 kgf/mm² at room temperature.

3. A transparent layered structure comprising:
a plate-like transparent resin base;
a transparent primer layer located on at least one surface of the transparent resin base; and
a transparent protective film located on the transparent primer layer, wherein
the transparent resin base has a heat resistance to temperatures greater than or equal to 70° C.,
the transparent protective film has a thickness greater than or equal to 5 μm and less than or equal to 80 μm, and includes a silicone resin composition including 9 wt % or more of cage silsesquioxane and fine particles subjected to a surface treatment with a silane compound and constituted by glass fine particles or metal oxide fine particles having a particle size greater than or equal to 10 nm and less than or equal to 100 nm,
the fine particles have a weight proportion greater than or equal to 5 parts by weight and less than or equal to 400 parts by weight with respect to 100 parts by weight of the silicone resin composition,
the silane compound has a weight proportion greater than or equal to 15 wt % and less than or equal to 80 wt % with respect to the fine particles, and
the primer layer includes acrylic resin and has a thickness greater than or equal to 5 μm.

4. The transparent layered structure of claim 3, wherein
the transparent resin base includes polycarbonate resin or acrylic resin, and has a substantially uniform thickness greater than or equal to 1 mm, an elastic modulus greater than or equal to 1 GPa at room temperature, and a Vickers hardness greater than or equal to 10 kgf/mm² at room temperature.

5. The transparent layered structure of claim 1, wherein
the transparent layered structure is a window material for an mobile object.

6. A method for producing the transparent layered structure of claim 1, the method comprising:
a preparation step of preparing a plate-like transparent resin base having a heat resistance to temperatures greater than or equal to 70° C., a substantially uniform thickness greater than or equal to 1 mm, and an elastic modulus greater than or equal to 1 GPa at room temperature;
an application step of applying a coating composition including a silicone resin composition onto at least one surface of the transparent resin base; and
a photocuring step of photocuring the coating composition with application of light at an ambient temperature lower than a heatproof temperature of the transparent resin base, thereby providing a transparent protective film on the transparent resin base, wherein
the silicone resin composition to be used in the application step includes fine particles subjected to a surface treatment with a silane compound, and is constituted by glass fine particles or metal oxide fine particles having a particle size greater than or equal to 10 nm and less than or equal to 100 nm.

7. A method for producing the transparent layered structure of claim 3, the method comprising:
a preparation step of preparing a plate-like transparent resin base having a heat resistance to temperatures greater than or equal to 70° C., a substantially uniform thickness greater than or equal to 1 mm, and an elastic modulus greater than or equal to 1 GPa at room temperature;
a first application step of applying a coating composition including acrylic resin onto at least one surface of the transparent resin base;
a second application step of applying a coating composition including a silicone resin composition including fine particles constituted by glass fine particles or metal oxide fine particles subjected to a surface treatment with a silane compound and having a particle size greater than or equal to 10 nm and less than or equal to 100 nm; and
a photocuring step of photocuring the coating composition with application of light at an ambient temperature lower than a heatproof temperature of the transparent resin base, thereby providing a transparent primer layer and a transparent protective film on the transparent resin base.

8. The transparent layered structure of claim 3, wherein
the transparent layered structure is a window material for an mobile object.
